(19) United States
(12) Patent Application Publication
(10) Pub. No.: US 2025/0273991 A1
(43) Pub. Date: Aug. 28, 2025

(54) REDUCED-FRINGING-FIELD CAPACITIVE WIRELESS POWER TRANSFER SYSTEM UTILIZING METASURFACE-BASED COUPLERS AND WAVEGUIDE STRUCTURES

(71) Applicant: Cornell University, Ithaca, NY (US)

(72) Inventors: Khurram Afridi, Ithaca, NY (US); Francesco Monticone, Ithaca, NY (US); Sounak Maji, Ithaca, NY (US); Syed Saeed Rashid, Ithaca, NY (US); Matteo Ciabattoni, Ithaca, NY (US); Dheeraj Etta, Ithaca, NY (US)

(21) Appl. No.: 19/060,363

(22) Filed: Feb. 21, 2025

Related U.S. Application Data
(60) Provisional application No. 63/557,241, filed on Feb. 23, 2024.

(51) Int. Cl. H02J 50/05; B60L 53/10; H02J 50/00; H02J 50/70

(52) U.S. Cl. CPC H02J 50/05; B60L 53/10; H02J 50/005; H02J 50/70

(57) ABSTRACT

A multi-MHz large air-gap capacitive Wireless Power Transfer (WPT) system achieves substantial fringing field reduction by utilizing metasurface-based coupling plates (referred to as ‘metacoupler’) and a waveguide structure. The metasurface has an impedance property that restricts the electric field lines from emanating outwards from the coupler leading to a more focused near-field energy transfer compared to a system with a conventional capacitive coupler. Placement of the couplers within two elongated metal sheets separated by a distance creates a waveguide, which aids significantly in field reductions. The metacoupler may be implemented in a capacitive WPT system using various different types of metasurfaces and waveguides.

### CROSS REFERENCE AND PRIORITY CLAIM

This patent application claims priority to U.S. Provisional Patent Application 63/557,241, filed Feb. 23, 2024, the disclosures of which are incorporated herein by reference in their entirety including the disclosures of cited publications referenced in U.S. Provisional Patent Application.

### GOVERNMENT FUNDING LANGUAGE

This invention was made with government support under DE-AR0001572 awarded by the U.S. Department of Energy-ARPA. The government has certain rights in the invention.

### FIELD

The present invention pertains to Wireless Power Transfer (WPT) systems, and more particularly, capacitive WPT systems for the charging of devices.

### BACKGROUND

WPT has become significant due to its convenience provided in Electric Vehicle (EV) charging application. The productivity of EVs and similar equipment is conventionally limited by the energy storage capacity of their batteries and their charging times. One approach to circumvent this is by wirelessly charging such equipment while they are operating. Thus, for example, WPT can potentially increase adoption of EVs by enabling stationary, semi-dynamic, and dynamic charging to help overcome their cost, charging time, and range limitations.

Conventionally, WPT systems for EVs utilize either magnetic fields between inductively coupled coils or electric fields between capacitively coupled plates to transfer power from the ground to the vehicle. However, inductive WPT systems for EVs use ferrites for flux guidance, which are expensive, heavy, and fragile (hence, difficult to embed in roadway). Additionally, large high-frequency losses in the ferrites limit the inductive systems' operating frequency and hence their potential for size reduction.

Capacitive WPT systems, on the other hand, do not require the dielectric material required for inductive coupled coils and are cheaper, lighter, and also easier to embed in roadway. Further, the absence of any dielectric also allows them to be operated at high frequencies without excessive losses, thus reducing their size. Moreover, capacitive WPT systems are also more efficient.

However, owing to a large air-gap and limited area available under vehicle chassis, designing high-power high-efficiency capacitive WPT systems for EV charging has been conventionally challenging. For example, a major imperative in such systems is to limit the fringing electric fields outside the vehicle chassis within the prescribed safety limits. One conventional approach to reducing fringing electric fields involves using dielectric medium for field focusing. However, the dielectric material introduces additional frequency-dependent losses in the system, and hence, is not suitable for high efficiency operation.

Recent developments in capacitive WPT systems have been shown to work for mobile robot applications. How, such conventional systems have not been designed to restrict the high strength high-frequency fringing electric fields in the surrounding charging premises, which is an important safety consideration, particularly with EVs. Still further, the design of various conventional capacitive metacouplers are not optimized, which leads to only a limited reduction in fringing electric fields. Furthermore, various designs conventionally involve a redundant outer ring, which leads to a decrease in power density.

### SUMMARY

Therefore, there is a need to reduce the fringing field levels compared to such conventionally known capacitive WPT systems. Accordingly, disclosed embodiments provide a multi-MHz large air-gap capacitive WPT system that achieves substantial fringing field reduction by utilizing metasurface-based coupling plates (referred to as ‘metacoupler’) and a waveguide structure. The metasurface has an impedance property that restricts the electric field lines from emanating outwards from the coupler leading to a more focused near-field energy transfer compared to a system with a conventional capacitive coupler.

In accordance with various embodiments, fringing field reduction may be solely realized by metacouplers implemented using capacitive metasurfaces.

In accordance with various embodiments, placement of the couplers within two elongated metal sheets separated by a distance creates a waveguide, which aids significantly in field reductions.

In accordance with various embodiments, outer plates of the metacoupler structures are also used for power transfer and are driven by a second inverter operating at 180° phase-shift with respect to first inverter, resulting in active field cancellation outside the couplers.

Various embodiments provide the inventive metacoupler may be implemented in a capacitive WPT system using various different types of metasurfaces and waveguides.

Additional features of the present disclosure will become apparent to those skilled in the art upon consideration of illustrative embodiments exemplifying the best mode of carrying out the disclosure as presently perceived.

### BRIEF DESCRIPTION OF THE FIGURES

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates an example of a conventionally known modular approach to designing capacitive WPT systems in which fringing electric fields are reduced by operating adjacent modules of a multi-modular system at a phase of 180° with respect to one another.

FIG. 2 shows an illustrative example of a topology of a conventionally known capacitive WPT system for EV charging.

FIG. 3 shows an example of a coupler in a capacitive WPT system that is conventionally implemented using a pair of conductive plates.

FIG. 4 shows an electric field distribution simulated when the conventional system is delivering 50 kW to the load.

FIG. 5 shows an example of a metacoupler where the plates are constituted of two types of surfaces: a circular surface closer to the center made up of perfect electrical conductor, and a ring-shaped metasurface closer to the perimeter having a distributed impedance.

FIG. 6 illustrates electric field intensity levels in a region surrounding coupling plates of a metacoupler-based capacitive WPT system designed in accordance with disclosed embodiments.

FIG. 7 illustrates various examples of physical implementations of a metacoupler designed in accordance with disclosed embodiments. The metacoupler of FIG. 7(a) comprises a metasurface with a capacitive impedance, and the metacoupler of FIG. 7(b) comprises a metasurface with an inductive impedance.

FIG. 8 shows a comparison of the simulated electric field intensities in a conventional-coupler-based capacitive WPT system with a metacoupler-based system having inductive and capacitive metasurfaces in accordance with the disclosed embodiments.

FIG. 9 shows simulated field intensities beyond the edge of the coupler illustrated in FIG. 8 for illustrative purposes.

FIG. 10 shows the fringing field strength at a distance of 15 cm from the edge of the coupler and predicted efficiency of different 13.56-MHz 3.7-kW capacitive WPT systems with the conventional coupler and various implementations of the metacoupler.

FIG. 11 illustrates an example of an elliptical capacitive metacoupler implemented using elliptical plates in accordance with disclosed embodiments.

FIG. 12 shows a comparison of electric field between conventional couplers to three different metacoupler designs provided in accordance with the disclosed embodiments.

FIG. 13 illustrates an electric field as a function of the distance from the center of the plate pairs. The plot highlights how increasing the gap size, g results in a decrease of fringing electric field.

FIG. 14 is an example of an elliptical capacitive plate design flowchart for optimizing the metacoupler.

FIG. 15(a) illustrates a two-ring elliptical capacitive metacoupler structure with relevant dimensions of the coupler highlighted;

FIG. 15(b) illustrates an overall schematic of the capacitive WPT system with two-ring elliptical capacitive metacouplers of FIG. 15(a).

FIG. 16 illustrates an example of a fringing electric field as a function of distance from the center of the plate pairs for single-ring and two-outer-ring metacouplers (both having the same inner plate area and gap size) compared to a conventional coupler.

FIG. 17(a) illustrates an example of a rectangular capacitive metacoupler structure with c-shaped outer plate.

FIG. 17(b) illustrates an overall schematic of the capacitive WPT system with the proposed rectangular capacitive metacouplers of FIG. 17(a).

FIG. 18 illustrates an example of a fringing electric field as a function of distance from the center of the plate pairs and the E-Field safety limit of 68 V/m are plotted.

FIG. 19 illustrates electric field vector lines from CST Microwave High Frequency Solver, wherein the top plot showing the E-field lines when a conventional coupler is excited and bottom shows the E-field lines when the metacoupler is excited with the same voltage source.

FIG. 20 plots fringing electric field and system efficiency of a capacitive WPT system implemented using rectangular metacouplers, plotted as a function of the gap size between the concentric rectangles.

FIG. 21 is an example of a rectangular capacitive metacoupler design flowchart for optimizing the metacoupler.

FIG. 22 is a plot of system efficiency with respect to peak voltage across air-gap at different values of system input voltages.

FIG. 23 is a simulation model for a capacitive wireless power transfer system incorporating the optimized rectangular metacoupler design, wherein the matching network is created using ideal inductors, as well as an aluminum backing plate and a teflon layer.

FIG. 24(a) is a plot of the resulting electric field when the metacoupler system is delivering 50-kW. The marker at a horizontal distance of 79 cm from the center of the plate pairs highlights the electric field below the safety limit at the desired edge.

FIG. 24(b) provides a contour plot of the electric field magnitude distribution in the metacoupler system; note how the electric field is concentrated towards the center of the inner plates, resulting in a strong fringing-field reduction.

FIG. 25 illustrates a plot of electric field decay for couplers between aluminum plates compared to the exponential decay of evanescent fields inside a parallel-plate waveguide under cutoff. For reference, cubic decay is also shown.

FIG. 26 illustrates a plot of electric field decay for couplers between aluminum plates i.e., a waveguide. The different lengths of waveguide are compared.

FIG. 27 illustrates a plot of electric field decay for couplers between aluminum plates, i.e., a waveguide. The different widths of waveguide are compared.

FIG. 28 illustrates an example of a capacitive wireless charging system with conventional couplers using cutouts in the extended aluminum plates of the parallel plate waveguide structure to shape electric field decay.

FIG. 29 illustrates an example of a capacitive wireless power transfer system utilizing rectangular metacouplers with c-shaped outer rings and waveguide structure formed by elongated aluminum backing plates to achieve significant field reductions efficiently.

FIG. 30 illustrates an example of a capacitive wireless power transfer system utilizing active fringing field reduction approach with rectangular metacouplers where outer C-shaped plates are also used for power transfer with the help of another set of WPT system components (i.e. inverter, rectifier and matching networks).

FIG. 31(a) is a photograph of an implemented rectangular conventional coupling plate.

FIG. 31(b) is a photograph of an implemented rectangular metasurface-based coupling plate.

FIG. 31(c) is a photograph of a 13.56-MHz 3-cm air-gap capacitive WPT system prototype.

FIG. 32(a) illustrates measured waveforms of the inverter switch-node voltages, the inverter output current, and the input dc current in the 13.56-MHz 3-cm air-gap capacitive WPT prototype utilizing rectangular conventional coupling plates.

FIG. 32(b) illustrates measured waveforms of the inverter switch-node voltages, the inverter output current, and the input dc current in the 13.56-MHz 3-cm air-gap capacitive WPT prototype utilizing rectangular capacitive metasurface based coupling plates.

FIG. 33 illustrates a comparison of electric field intensity levels as a function of distance from the center of the plate-pairs in the two capacitive WPT prototypes utilizing rectangular conventional couplers, and rectangular capacitive metasurface based couplers.

FIG. 34(a) is a photograph of an implemented conventional coupling plate.

FIG. 34(b) is a photograph of an implemented metasurface-based coupling plate.

FIG. 34(c) is a photograph of a 13.56-MHz 12-cm air-gap capacitive WPT system prototype.

FIG. 35(a) shows measured waveforms of the inverter switch-node voltages, the inverter output current, and the input voltage in the 13.56-MHz 12-cm air-gap capacitive WPT prototype utilizing conventional coupling plates

FIG. 35(b) shows measured waveforms of the inverter switch-node voltages, the inverter output current, and the input voltage in the 13.56-MHz 12-cm air-gap capacitive WPT prototype utilizing capacitive metasurface based coupling plates.

FIG. 36 illustrates a comparison of electric field intensity levels as a function of distance from the center of the plate-pairs in the two capacitive WPT prototypes utilizing conventional couplers, and capacitive metasurface based couplers.

FIG. 37 illustrates an example of a rectangular metacoupler implemented in a capacitive WPT system.

FIG. 38 illustrates an example of a metacoupler implemented in a capacitive WPT system.

FIG. 39 illustrates a topology of a capacitive WPT system with single-stage L-section matching networks.

FIG. 40 provides a conceptual metasurface-based coupling plate.

FIG. 41 shows a cross-sectional view of the proposed charging pad. (Cross-section of one side. The other side is identical)

FIG. 42 provides A top view of the proposed charging pad.

FIG. 43(a) is an illustrative diagram for a practical charging scenario for mobile robots' charging.

FIG. 43(b) incorporating parasitic capacitances for the concept shown in FIG. 43(a) except diagonal capacitances (for clarity).

FIG. 44 illustrates a complete physical model of the couplers with parasitics (all cross capacitances are highlighted in red).

FIG. 45(a) illustrates an equivalent electrical model of the system with parasitics (diagonal capacitances not shown for clarity).

FIG. 45(b) illustrates a full equivalent electrical model of the system with all parasitic capacitances.

FIG. 46(a) illustrates an equivalent circuit model after split inductor symmetry and incorporating diagonal capacitances.

FIG. 46(b) shows a final simplified four-capacitance model.

FIG. 47 illustrates an example of a summary of optimization methodology to pick metasurface-based coupling plates dimensions while being efficient, within electric field safety limits and satisfying a power transfer density constraint.

FIG. 48 illustrates a variation of coupling capacitance Cₛ of the metacouplers with increasing gap (g) between inner plate and outer ring. Matching network efficiency is highlighted for each point.

FIG. 49 plots fringing electric fields for various gap sizes (g).

FIG. 50 plots simulated electric fields after applying 2 kV across coupling plates on FEM tool is within electric field safety limits, by using metacouplers as compared to conventional couplers.

FIG. 51(a) is a photograph of conventional couplers.

FIG. 51(b) is a photograph of metasurface-based capacitive couplers designed in accordance with the disclosed embodiments.

FIG. 51(c) is a photograph of a capacitive WPT experimental prototype using conventional couplers.

FIG. 51(d) is a photograph of a capacitive WPT experimental prototype using metacouplers designed in accordance with disclosed embodiments.

FIGS. 52(a)-(b) plots measured operating waveforms of the two 13.56-MHz 3-cm air-gap high power density capacitive WPT prototypes operating at 500 Vpk air-gap voltage for electric field measurements.

FIG. 52(a) plots input, inductor currents and inverter switch-node voltages for WPT prototype using conventional coupler.

FIG. 52(b) plots input, inductor currents and inverter switch-node voltages for WPT prototype using metasurfaced-based couplers.

FIG. 53 plots measured electric fields at 2 kV across coupling plates by using metacouplers as compared to conventional couplers. A 3.3× reduction is observed in electric fields.

FIG. 54 illustrates an equivalent circuit model after split inductor symmetry and incorporating diagonal capacitances (pi-network within the circuit highlighted in green).

FIG. 55(a) illustrates an equivalent circuit model after Pi-T transformation (T-network within the circuit highlighted in green).

FIG. 55(b) illustrates an equivalent circuit model after splitting capacitors CT,1 and CT,2.

FIG. 56 illustrates an equivalent circuit model after combining Cg,eq and split CT,1 & CT,2. capacitances (T-network within the circuit highlighted in green).

FIG. 57 illustrates an equivalent circuit model after T-Pi transformation (pi-network within the circuit highlighted in green).

FIG. 58 illustrates a final simplified four-capacitance model.

FIG. 59 illustrates a physical model of the couplers with different diagonal (or cross) capacitances.

FIGS. 60(a)-(d) show various conceptual models provided to illustrate the theory of the disclosed embodiments of the metacoupler.

FIGS. 61(a)-(d) show various conceptual models provided to illustrate the theory of the disclosed embodiments of the metacoupler including various options for how conductive and laterally adjacent plates may be oriented relative to one another.

FIGS. 62(a)-(h) show various conceptual models provided to illustrate the theory of the disclosed embodiments of the metacoupler including at least one pair of laterally adjacent conductive plates may be connected using at least one lumped impedance element.

FIGS. 63(a)-(b) show conceptual models provided to illustrate the theory of the disclosed embodiments of a metacoupler with potential connection of unconnected outer plates to provide active field cancellation discussed with reference to FIGS. 108 and 111.

FIG. 64 shows a conceptual model provided to illustrate the theory of the disclosed embodiments of the metacoupler.

FIG. 65 shows a conceptual models provided to illustrate the theory of the disclosed embodiments of a waveguide-metacoupler structure.

FIG. 66 shows a conceptual model provided to illustrate the theory of the disclosed embodiments of a waveguide-metacoupler structure implemented using the two metacouplers capacitively coupled together as shown in FIG. 64.

FIG. 67 shows a conceptual model provided to illustrate the theory of the disclosed embodiments of a capactive wireless power transfer system.

FIG. 68 shows a conceptual model provided to illustrate the theory of the disclosed embodiments of the a capacitive wireless power transfer system also employing the waveguide metacoupler structure as described with reference to FIG. 61.

FIG. 69 shows a conceptual model provided to illustrate the theory of the disclosed embodiments of a metacoupler with plates used to implement the waveguide structure, wherein the plates are elongated to encompass additional laterally positioned plates as described with reference to FIG. 66.

FIG. 70(a) illustrates an example of a configuration pf a WPT system that enables power transfer from the primary to the secondary-side exclusively through the inner plates.

FIG. 70(b) exhibits the clear tradeoff between the reduction of fringing electric field and the system's efficiency.

FIG. 71 illustrates an architecture for metasurface-based capacitive WPT systems transferring power from both outer rings and inner plates.

FIG. 72 illustrates a cross-sectional view of an architecture utilizing both inner plates and outer rings for power transfer.

FIG. 73 provides a conceptual figure of a cross-sectional view of metacouplers when the inner plates and outer rings are out-of-phase.

FIG. 74 charts the effect of increasing percentage of power transferred through outer rings on simulated electric field for an example 6.78-MHz 2-kW capacitive WPT system, simulated in Ansys HFSS.

FIG. 75 charts the effect of increasing percentage of power transferred through outer rings on overall system efficiency for an example 6.78-MHz capacitive WPT system.

FIG. 76 charts the variation of simulated electric field (Ansys HFSS) with the phase-shift between two inverters, located 79 cm from the center of charging pads.

FIG. 77(a) is a photographic image of conventional couplers, (b) designed metasurface-based capacitive couplers, and (c) capacitive WPT experimental prototype.

FIG. 78(a) charts measured operating waveforms of the capacitive WPT prototype, using metacouplers.

FIG. 78(b) charts measured operating waveforms while delivering 1.1-kW at 87.6% efficiency to a 40Ω load, wherein 10% power is processed through outer plate and the phase difference between the two inverters is 240°.

FIG. 79(a) charts measured operating waveforms of the capacitive WPT prototype using conventional couplers, achieving an overall efficiency of 91%.

FIG. 79(b) charts measured operating waveforms using metacouplers in accordance with the disclosed embodiments, without power transfer from outer ring, achieving an overall efficiency of 84%.

FIG. 80 charts the measured operating waveforms of the capacitive WPT prototype in FIG. 77(b) while delivering 1.1-kW at 87.6% efficiency to a 40Ω load.

FIG. 81 charts measured electric field at 130 W of output power, wherein an experimental 3.8× reduction in electric field may be observed to a conventional coupler.

FIG. 82 shows a conceptual model provided to illustrate the theory of the disclosed embodiments of a capacitive wireless power transfer system as shown in FIG. 67 but with an additional inverter, matching network pair and an additional matching network, rectifier pair interfaced with the laterally adjacent plates to perform active field cancellation.

FIG. 83 shows a conceptual model provided to illustrate the theory of the disclosed embodiments of a capactive wireless power transfer system using a waveguide metacoupler.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As used herein, the term “plates” is used to refer to materials that provide the disclosed functionality and may refer to any conductive structure. For example, plates can be implemented using various conductive materials and configurations, including but not limited to:

1. Thin metal plates formulated using conductive plates made from metals such as copper, aluminum, or silver, designed to function as electrodes in capacitive coupling applications. These can be rigid or flexible, depending on the structural and electrical requirements of the system.

2. Metal layers provided as conductive layers deposited or integrated onto a substrate, typically through processes such as electroplating, Chemical Vapor Deposition (CVD), or sputtering. Such layers can, for example, be embedded within dielectric materials or printed on circuit boards for compact implementations.

3. Metal foil layers implemented using ultra-thin conductive films, e.g., made of materials such as aluminum or copper, which provide electrical conductivity while minimizing weight and material thickness. Such an implementation may have particular technical utility in applications where flexibility and lightweight construction are critical.

As used herein, the term “metacoupler” refers to a structure implemented using metasurface based couplers, which are couplers that utilize metasurface-based coupling plates to control the distribution of fringing electric fields. Unlike conventional couplers, which exhibit high fringing fields due to the inability of perfect electrical conductors (PECs) to support tangential electric fields, metasurface-based couplers leverage a finite surface impedance to sustain tangential electric fields. This enables the ability to sculpt electric field lines at the plate edges, effectively reducing lateral fringing fields without increasing system volume, as seen with convex curved plates.

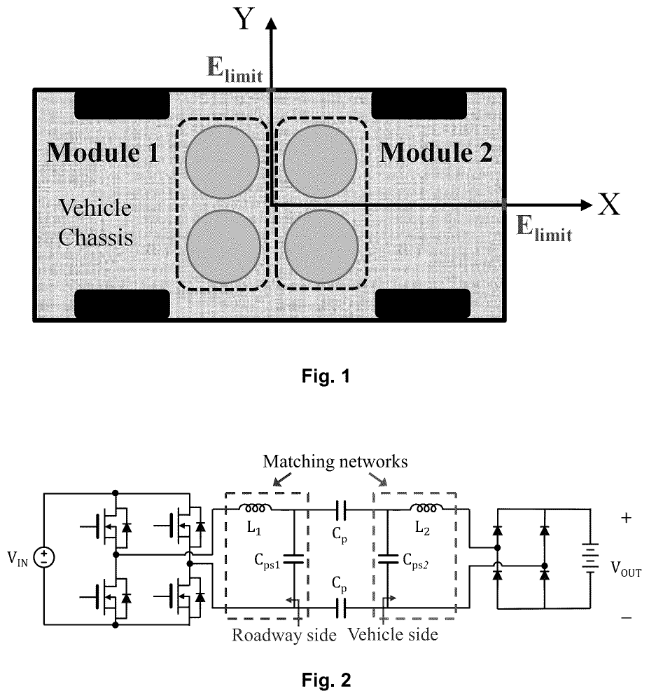

Various disclosed embodiments utilize modular approaches to designing capacitive WPT systems to reduce fringing electric fields by operating adjacent modules of a multi-modular system at a phase of 180° with respect to one another. FIG. 1 illustrates a top view of a multi-module capacitive WPT system so designed wherein fringing electric fields are reduced by operating the adjacent modules at a phase of 180° with respect to one another. However, adapting such a system is difficult in a dynamic charging scenario where a complicated phase relationship may be required between adjacent modules when, for example, an EV or other equipment powered by battery is moving. This escalates the need for an approach to reduce the fringing fields that uses a single module.

FIG. 2 shows an illustrative example of a topology of a conventionally known capacitive WPT system for EV charging, wherein power is transferred wirelessly in this system by using a pair of couplers (each coupler comprising two coupling plates) separated by, for example, in an EV based implementation, a ground clearance of the EV.

In this conventionally known approach, a high-frequency inverter is used to convert the DC input voltage into a high-frequency AC voltage, which is then stepped up by, for example, a roadway-side (or transmitter-side) matching network. This configuration enables a high voltage across the roadway-side coupling plates and allows large power transfer with relatively small displacement current through the plates, and hence, relatively small fringing fields. Another matching network on the vehicle-side (or receiver-side) then steps up this current, and steps down the voltage, to a level required to charge the EV battery. The L-section matching networks in this system also compensate for the capacitive reactance of the coupler. The matching network capacitances in this system are implemented solely by utilizing the parasitic capacitances present in the charging environment enabling enhanced reliability and efficiency.

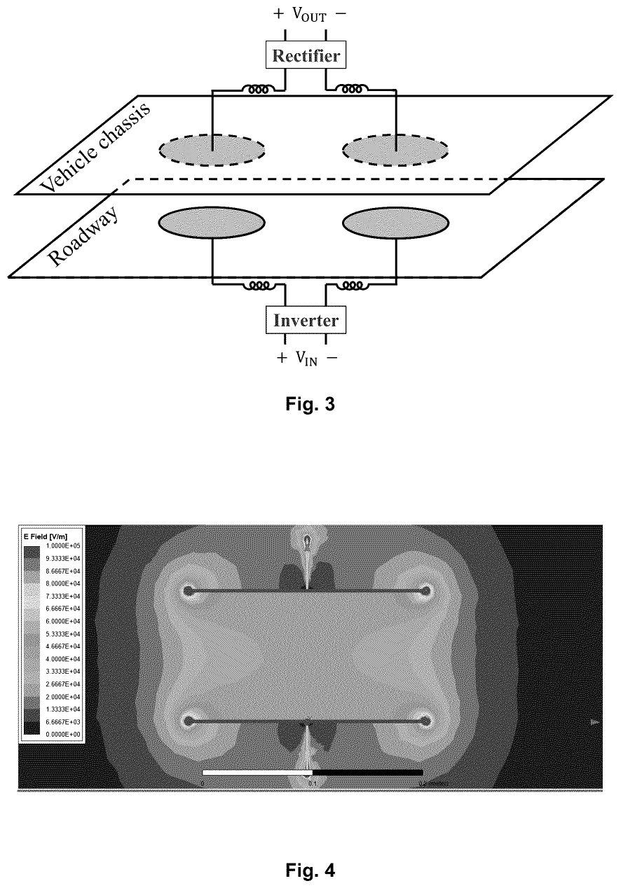

FIG. 3 shows an example of a coupler in a capacitive WPT system that is conventionally implemented using a pair of conductive plates. In order to analyze the performance of such a conventional coupler, a 13.56-MHz 50-kW capacitive WPT system suitable for EV charging may be designed using the approach presented in F. A. Spelman, “The Past, Present, and Future of Cochlear Prostheses,” IEEE Engineering in Medicine and Biology Magazine, vol. 18, no. 3, pp. 27-33, May-June 1999. Further analysis, thereafter requires simulation of the resultant fringing electric field in the vicinity of the conventional coupler using, for example, Ansys an HFSS electromagnetic field simulator. In such a simulation, the roadway and the vehicle chassis may be emulated with 1-m×1-m aluminum sheets.

With this understanding of the conditions of simulation in mind, FIG. 4 shows an electric field distribution simulated when the conventional system is delivering 50 kW to the load. Due to fringing effect, the field intensity is high in the region surrounding the coupler. For example, the electric field strength at a distance of 15 cm from the edge of the coupler is found to be 300 V/m, much larger than the permitted safety limit of 108 V/m at 13.56 MHz.

With this understanding of the limitations of conventionally known systems, it should be appreciated that there is a need for improvements in the technology for implementing multi-MHz large air-gap capacitive WPT systems and their components.

Accordingly, various disclosed embodiments are provided to implement a multi-MHz large air-gap capacitive WPT system that achieves substantial fringing field reduction by utilizing metasurface-based coupling plates (i.e., the ‘metacoupler’) and a waveguide structure. The metasurface has an impedance property that restricts the electric field lines from emanating outwards from the coupler leading to a more focused near-field energy transfer compared to a system with a conventional capacitive coupler.

Disclosed embodiments are partially based on the recognition that, conventionally, the reason for high fringing field levels in WPT systems is that Perfect Electrical conductors (PECs) cannot support tangential electric fields, forcing the field lines to emanate normally from the edge-surface and extend in the lateral direction. Convex curved plates are conventionally known to reduce the lateral extension of fringing fields due to their non-planar charge distribution (most of the charge accumulates near the center of the plates where the air-gap is minimum). However, they occupy a much larger space as compared to a conventional coupler, which increases a system's overall volume.

Disclosed embodiments address these technical limitations by providing a metacoupler that leverages the concept of metasurfaces to realize similar fringing field distribution as convex curved plates.

To expand upon the relationships of relevant characteristics, it should be understood that a metasurface with a finite impedance can sustain tangential electric fields, wherein the strength of the tangential electric field in a metasurface is given by:

$${E}_{ta n} = {Z}_{s} ( \hat{n} \times {H}_{ta n} ) ,$$

where Zₛ is the impedance of the metasurface and Hₜₐₙ is a measure of the current flowing through the metasurface. Therefore, electric field lines that would normally emanate from an edge of the coupling plates can be sculpted by configuring the plates' outer perimeters to have a finite impedance. Hence, couplers comprising such metasurface based coupling plates (i.e., metacouplers) can be used reduce the intensity of the fringing electric fields compared to conventional couplers.

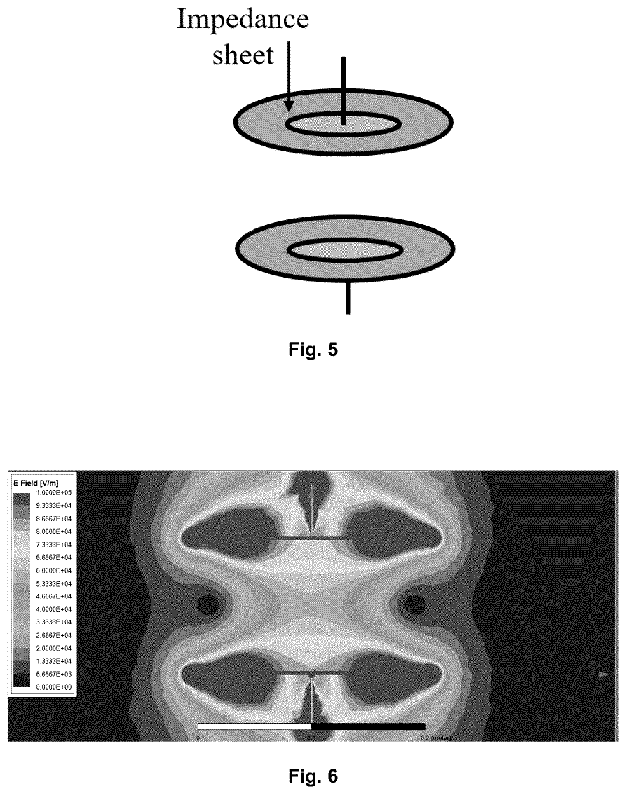

FIG. 5 shows such a metacoupler in which the plates are constituted of two types of surfaces: a circular surface closer to the center made up of perfect electrical conductor, and a ring-shaped metasurface closer to the perimeter having a distributed impedance.

FIG. 6 shows the electric field intensity levels in the region surrounding the coupling plates in a 13.56-MHz 50-kW capacitive WPT system (i.e., having the same specifications as the conventional-coupler-based system) designed using a metacoupler in accordance with the disclosed embodiments. It can be seen that the metacoupler restricts the high-strength fields to the air-gap within the coupler and substantially reduces field intensities in regions beyond the coupler.

In accordance with the various disclosed embodiments, there can be many possible ways to physically implement metacouplers.

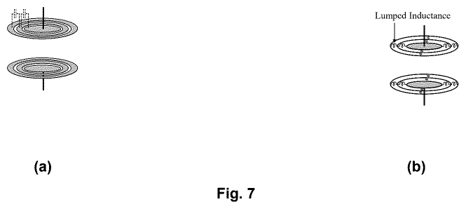

In one particular implementation, the distributed impedance of the metasurface for the metacoupler can be realized in a practical capacitive WPT system using a series of lumped impedances, as shown in FIGS. 7(a)-(b). The metacoupler of FIG. 7(a) comprises a metasurface with a capacitive impedance, and the metacoupler of FIG. 7(b) comprises a metasurface with an inductive impedance. The capacitive metacoupler of FIG. 7(a) may be implemented by placing two annular copper rings concentrically with an inner circular copper surface with an air-gap between two consecutive surfaces forming a lumped capacitance. The inductive metacoupler of FIG. 7(b) may be implemented by inserting lumped inductors between these copper surfaces.

To emulate a continuous impedance surface more precisely, multiple concentric rings with increasing diameter and multiple layers of lumped inductors can be used.

In accordance with various embodiments, fringing field reduction may be solely realized by metacouplers implemented using capacitive metasurfaces.

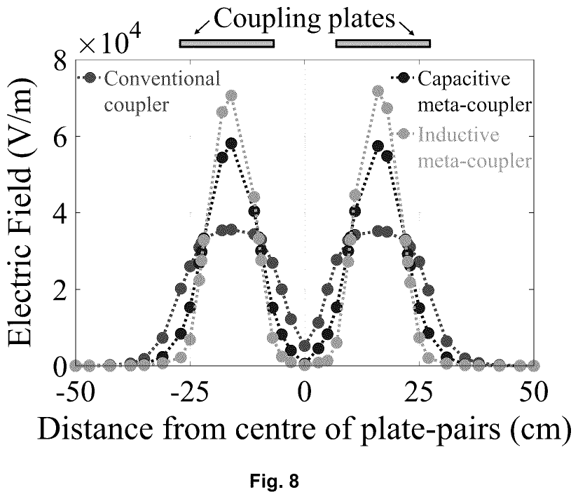

FIG. 8 shows a comparison of the simulated electric field intensities in a conventional-coupler-based capacitive WPT system with a metacoupler-based system having inductive and capacitive metasurfaces in accordance with the disclosed embodiments. In this example illustration, both the conventional coupler and the metacouplers have an overall diameter of 22 cm, and the metacouplers have an inner circular plate diameter of 12 cm. More specifically, FIG. 8 shows a comparison of electric field intensity levels as a function of distance from the center of the plate-pairs in capacitive WPT systems utilizing a conventional coupler, a capacitive metasurface based coupler configured in accordance with disclosed embodiments and an inductive metasurface based coupler configured in accordance with disclosed embodiments. For reference, dimensions of the coupling plates are shown on the top of the illustration.

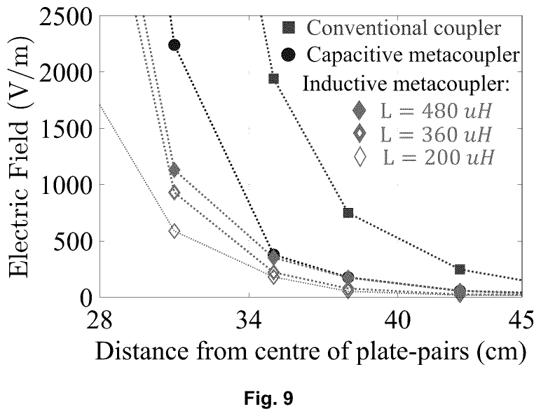

It can be seen from FIG. 8 that, although the systems with the inventive metacouplers have higher field levels in between the coupling plates, it falls drastically below that of the conventional coupler beyond the edge of the coupler. For reference, the simulated field intensities beyond the edge of the coupler are shown in FIG. 9, which shows a comparison of electric field intensity levels as a function of distance from the center of the plate-pairs in capacitive WPT systems utilizing a convention coupler, and metacouplers with different metasurface implementations.

It should be appreciated that, since the metacouplers of the disclosed embodiments utilize a smaller effective area for power transfer, the efficiency of a metacoupler-based system will be lower than a conventional-coupler based system because the efficiency of a metacoupler-based system depends on the diameter of the coupler's inner circular plate, as well as the implementation of the metasurface.

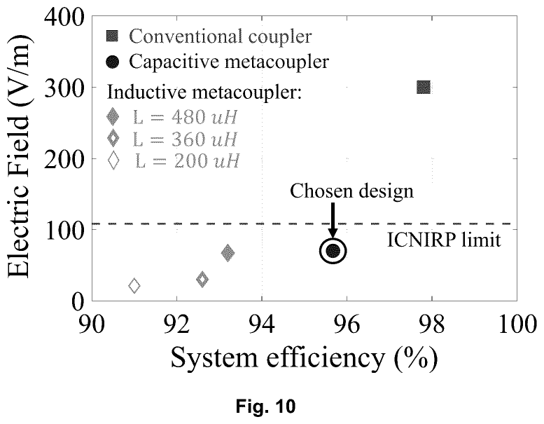

FIG. 10 shows the fringing field strength simulated at a distance of 15 cm from the edge of the coupler and predicted efficiency of different 13.56-MHz 3.7-kW capacitive WPT systems with the conventional coupler and various implementations of the metacoupler. As can be seen in FIG. 10, all the inductive and capacitive metacoupler-based systems exhibit significantly smaller fringing field levels compared to the conventional-coupler-based system and meet the electric field safety limit; however, among them, the system with the capacitive metacoupler achieves the highest efficiency. Thus, considering the ease of implementation and its superior efficiency, the capacitive metacoupler provides the maximum technical utility for designers seeking to incorporate metacouplers in capacitive WPT systems for fringing field reduction.

With this understanding in mind of a partial basis of the design of capacitive metacouplers in accordance with the disclosed embodiments, it should be understood that there are various different implementations of a capacitive metacoupler within the scope of the invention. As a result, a complete understanding of their technical utility is provided while examining different coupling plate shapes and outer conductive plate(s) placements. Each should be appreciated that each potential configuration involves variations in the dimensions of the inner and outer plates, and assessment of the various configurations involves trade-offs between system efficiency and achievable fringing field reduction levels.

To assess and validate the technical utility of the disclosed embodiments, a tailored design for a specific application may be used in which protocols adher to a targeted system power density of 150 kW/m² while delivering a 50-kW output, requiring a total area of each metacoupler to be 0.165 m². This dimensional constraint results from dividing the total output power by the power transfer density constraint and distributing it among two equally paired couplers. As a result, this example protocol not only underscores the practical viability of the disclosed embodiments but also demonstrates their applicability within the defined target specifications.

FIGS. 11(a)-(b) illustrate an example of an elliptical capacitive metacoupler implemented using elliptical plates in accordance with disclosed embodiments. FIG. 11(a) shows an example of the physical implementation of an elliptical capacitive metacoupler with the relevant dimensions of the coupler identified. Likewise, FIG. 11(b) provides an example of an overall schematic diagram of the capacitive WPT system with such elliptical capacitive metacouplers in accordance with disclosed embodiments.

When considering the dimensions illustrated in FIG. 11(a), is should be remembered that the area of each coupler must be 0.165 m²; this means that the outer radii of the ellipse are fixed at 0.38 m and 0.138 m. Also, the minimum lateral distance between the two sets of plates, s, is fixed at 10 cm and the vertical separation between the road-side and vehicle-side plates is fixed at 12 cm. Thus, a gap with size g mm is added on the plates to separate each plate into an inner ellipse and an outer ring, creating a lumped capacitance on each plate. The dimensions of the inner ellipse and outer ring would, therefore, be modified according to a scaling constant that relates the outer and inner radii as follows:

$$k = \frac{{b}_{i}}{{b}_{o}} = \frac{{a}_{i}}{{a}_{o}}$$

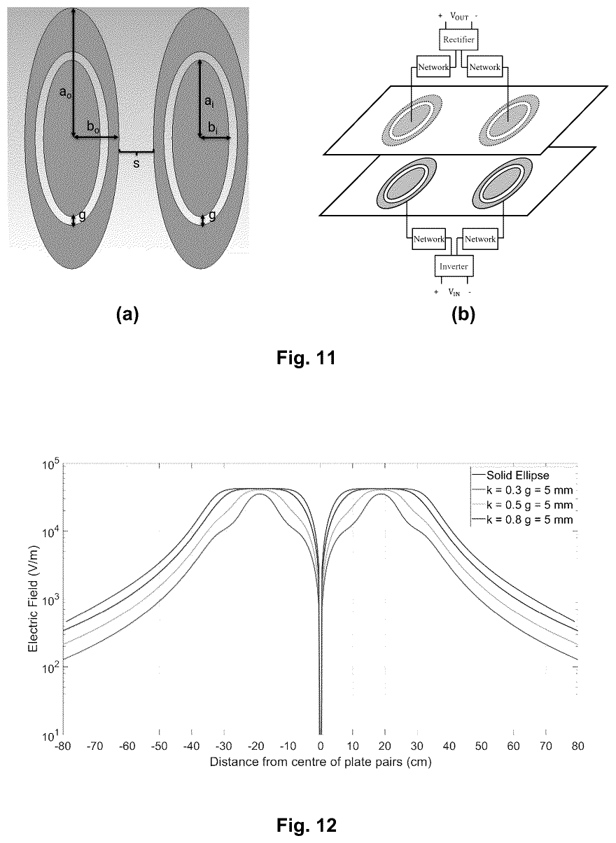

In order to gain an understanding of how the gap size between the inner ellipse and the outer ring or the scaling constant affects the fringing electric field, simulation of various designs are now discussed with comparison of each design to a set of conventional couplers. For example, FIG. 12 shows the comparison of electric field between the conventional couplers to three different metacoupler designs having a fixed gap of 5 mm and varying values of k.

As shown in FIG. 12, electric fields are charted as a function of the distance from the center of the plate pairs for a single outer ring elliptical metacoupler in comparison with a conventional coupler. The plot highlights how decreasing the value of k results in a decrease in the area of the inner ellipse results in a lower fringing electric field. By lowering k to 0.3, a 3.45× fringing field reduction compared to conventional elliptical couplers can be achieved.

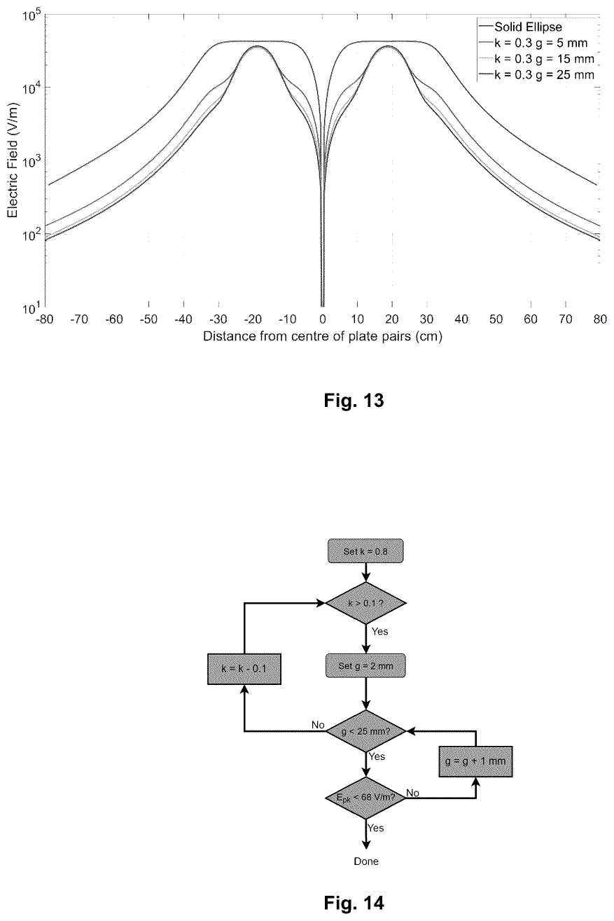

Next, the fringing electric field magnitude is simulated when the gap size is increased. The results are shown in FIG. 13, which plots electric field as a function of the distance from the center of the plate pairs. The plot highlights how increasing the gap size, g results in a decrease of fringing electric field. Three different elliptical metacouplers, each having a constant k value and different gap sizes between 5 to 25 mm are considered. As can be seen, increasing the gap size leads to an overall reduction in fringing electric field and by increasing the gap size to 25 mm, a 5.4× fringing field reduction compared to the conventional coupler can be achieved.

With the information acquired from the two charts presented in FIGS. 12 and 13, it should be appreciated that a basic design flowchart may be devised that theoretically assists in designing an elliptical metacoupler in accordance with the disclosed embodiments. Thus, FIG. 14 shows an example of an elliptical capacitive plate design flowchart for optimizing the metacoupler. As can be seen in FIG. 14, design operations start by setting a scaling constant, e.g., to 0.8 (meaning the inner radii are 0.8× the outer radii). In this design protocol, the gap between the plates is then set to be 2 mm and field at the chassis edge may be measured from simulations. If the fringing field is higher than the safety limit, the gap may be increased until a gap value of 25 mm. Past this value, the gap size may be reset to 2 mm, the radii scaling constant may be reduced by 0.1 and the fields at the chassis edge may be calculated.

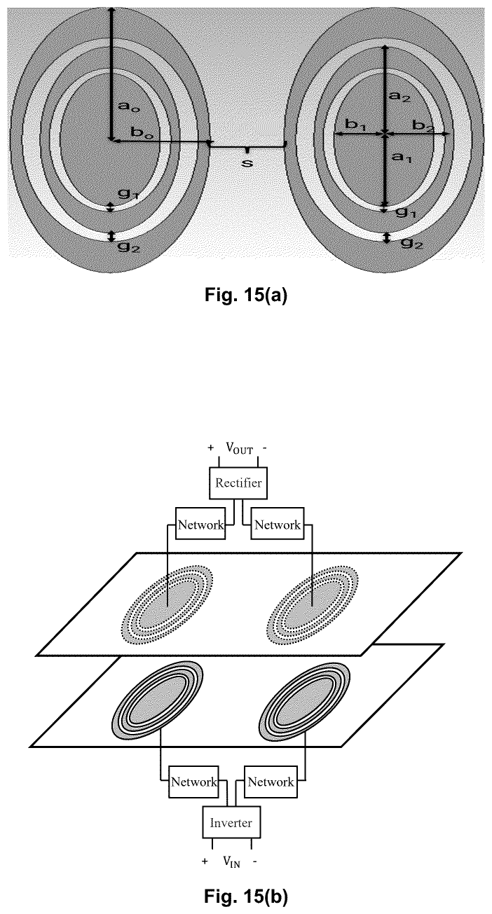

To obtain more degrees of freedom, while keeping the same plate area an additional ring may be added to the metacoupler, as shown in FIGS. 15(a)-(b). More specifically, FIG. 15(a) illustrates a two-ring elliptical capacitive metacoupler structure with relevant dimensions of the coupler highlighted. FIG. 15(b) illustrates an overall schematic of the capacitive WPT system with two-ring elliptical capacitive metacouplers of FIG. 15(a).

It should be understood that this configuration creates another ring around the central inner ellipse whose radii can be scaled with its own scaling constant, using:

$${k}_{i} = \frac{{b}_{i}}{{b}_{o}} = \frac{{a}_{i}}{{a}_{o}}$$

where i=1 for the middle ring and i=2 for the outer ring. As in the design with a single ring, the minimum lateral separation between the plates can be kept constant at 10 cm while the vertical separation between the plates can be kept constant at 12 cm.

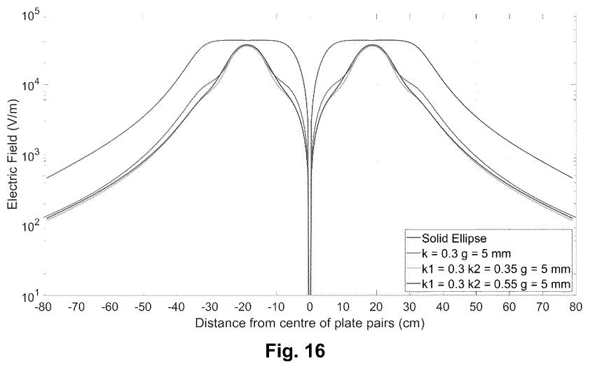

To understand the impact of the middle ring size on the fringing electric field, the electric field magnitude for the solid elliptical couplers, single ring-based elliptical metacouplers and two wings-based metacouplers are simulated and the results are shown in FIG. 16. As shown in that figure, the magnitude of the fringing electric field is a function of distance from the center of the plate pairs for single-ring and two-outer-ring metacouplers (both having the same inner plate area and gap size) compared to a conventional coupler. In the simulations of FIG. 16, the gap size in all designs is kept fixed at 5 mm and only the size of the middle ring size (k₂) is changed to quantify the reduction in fringing electric field. As can be seen from FIG. 16, while a 4× reduction in fringing electric field can be achieved in comparison to the conventional solid ellipse coupler using a two ring-based elliptical metacoupler, only a 1.17× reduction is achieved compared to the single ring design having the same gap size and inner ellipse size. As a result, the various design considerations are related and require careful consideration.

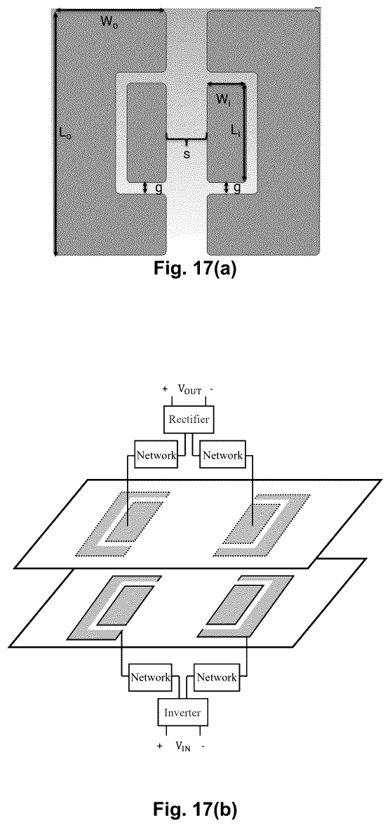

FIGS. 17(a)-(b) illustrate an embodiment implementing a rectangular capacitive metacoupler with a c-shaped outer plate configured to optimize the utilization of the available plate area, wherein the metacouplers may be configured as rectangular entities. More specifically, FIG. 17(a) illustrates an example of a rectangular capacitive metacoupler structure with c-shaped outer plate. FIG. 17(b) illustrates an overall schematic of the capacitive WPT system with the proposed rectangular capacitive metacouplers of FIG. 17(a).

The choice of whether to have a rectangular shape may be driven by a designer's objective of maximizing overlap time between roadside and vehicle-side coupling plates, aligning with the motion direction of the vehicle-side application (which in this design example is charging an electric vehicle battery). This design approach includes the use of a C-shaped conducting plate to form a C-shaped impedance sheet enclosing the coupling plates. The dimensions of the plates may be strategically set, with the outer length and width fixed at Wₒ=0.275 m and Lₒ=0.6 m, ensuring the attainment of the required plate surface area of 0.165 m². When designing the metacoupler, there are three degrees of freedom to consider. The inner conducting plates' lengths and widths can be scaled proportionally using respective scaling constants, denoted as:

$${k}_{L} = \frac{{L}_{i}}{{L}_{o}} , {k}_{W} = \frac{{W}_{i}}{{W}_{o}}$$

establishing their relationships with the outer lengths and widths. This scaling mechanism enables flexibility in tailoring the metacoupler dimensions while adhering to the specified outer plate dimensions and achieving the desired surface area. The final degree of freedom within the metacoupler design is the gap (g) between the inner and outer sections of the plates that plays a pivotal role. While the vertical separation between the road-side and vehicle-side plates remains fixed at 12 cm and their lateral separation(s) is set at 10 cm, the gap introduces a dynamic parameter that influences the overall performance of the system.

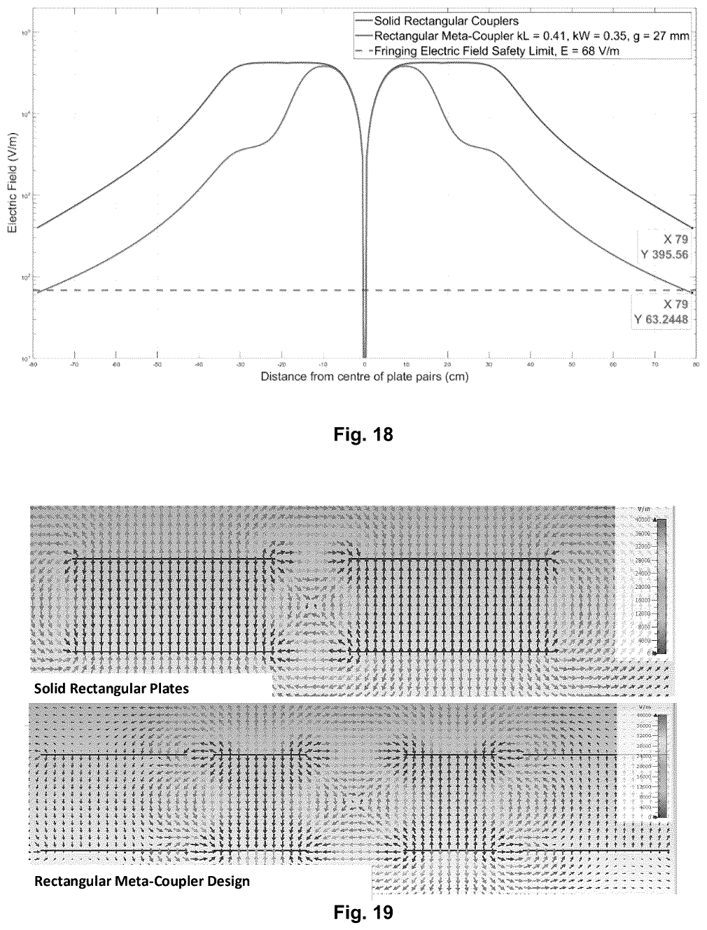

An illustrative example of the rectangular metacoupler, a 27 mm gap and an inner conducting plates' dimension of 0.24 m in length and 0.1 m in width, may yield a remarkable 6.25× fringing field reduction when compared to a conventional coupler. This reduction is crucial for mitigating electric fields in the environment. See FIG. 18 which illustrates an example of a fringing electric field as a function of distance from the center of the plate pairs and the E-Field safety limit of 68 V/m are plotted. It should be understood that, with this metacoupler design, one can limit the electric fields in the environment by constraining the air-gap voltage i.e., voltage across a pair of couplers. Constraining the peak voltage at 5 kV across the pair of metacouplers, the design effectively ensures that fringing electric fields at the edges of the underside of the electric vehicle (located 79 cm away from the center of the pair of metacouplers), as depicted in FIG. 18, remain below the safety limit. The orange curve in the plot falls just below the fringing electric field safety limit of 68 V/m attesting to the success of the design.

FIG. 19 provides further insight into the electric field vector plots for both capacitive WPT systems, one utilizing a pair of conventional couplers and the other employing a pair of rectangular metacouplers in accordance with disclosed embodiments. FIG. 19 illustrates electric field vector lines from CST Microwave High Frequency Solver, wherein the top plot showing the E-field lines when a conventional coupler is excited and bottom shows the E-field lines when the Metacoupler is excited with the same voltage source.

Notably, the use of rectangular metacouplers concentrates the electric field in the gap between the inner and outer sections of a metacoupler. The addition of a gap that divides the inner and outer sections of the plates facilitates a more rapid decay of the electric field compared to the pair of conventional couplers, as depicted in the plot of FIG. 19. Thus, this design modification may serve to enhance the efficiency and safety of the capacitive WPT system in accordance with various disclosed embodiments of the metacoupler design.

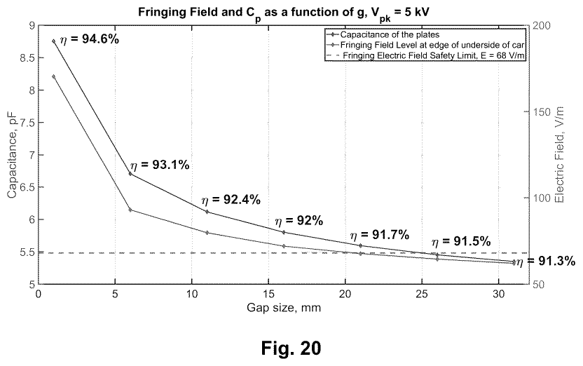

Of note, however, a capacitive WPT system also needs to operate above a desired efficiency, e.g., 95%, to transfer large power without dissipating much heat in its components. Recognizing that a significant portion of losses in a high-frequency capacitive WPT system arises from its matching network inductors, disclosed embodiments also focus on mitigating these losses. However, the addition of a gap between an inner conducting plate and an outer C-shaped conducting plate in a metacoupler introduces a series capacitance that concurrently reduces the overall coupling capacitance between the primary and the secondary side. It is important to note that this reduction in coupling capacitance necessitates a larger inductor to compensate for the coupling reactance, leading to increased losses in the system. This intricate balance is visually represented in FIG. 20, which plots fringing electric field and system efficiency of a capacitive WPT system implemented using rectangular metacouplers, plotted as a function of the gap size between the concentric rectangles. The figure depicts the system efficiency and fringing electric field at the desired edge for a capacitive WPT system employing a pair of rectangular metacouplers, with varying gap sizes (g). Notably, a larger gap size proves effective in reducing fringing fields below safety limits. However, it is accompanied by a decrease in system efficiency. As a result, it is evident that the choice of gap size is a critical factor in optimizing system performance, considering the trade-off between mitigating fringing fields, and maintaining high efficiency.

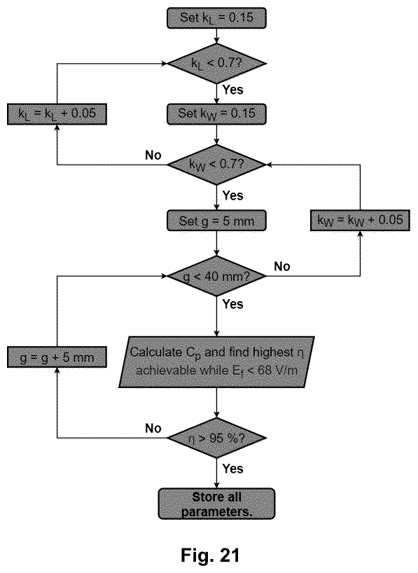

Accordingly, to optimize the design of the rectangular metacoupler, an example of a systematic algorithm for such design is outlined in FIG. 21. As shown in that figure, the iterative design process may begin by setting length and width scaling constants, e.g., to 0.15. Subsequently, the gap between the plates may be initialized, e.g., at 5 mm, and a fringing field at the chassis edge may be measured through simulations. Should the fringing field exceed the safety limit, the algorithm may adjust the gap, length, and width scaling constants iteratively until a design is achieved that ensures a safe fringing field outside the chassis edge while concurrently maximizing the system efficiency. Utilizing this optimization algorithm, an optimal design may be identified, restricting the electric fields within safety limits, and yielding an acceptable system efficiency, e.g., 93.5%.

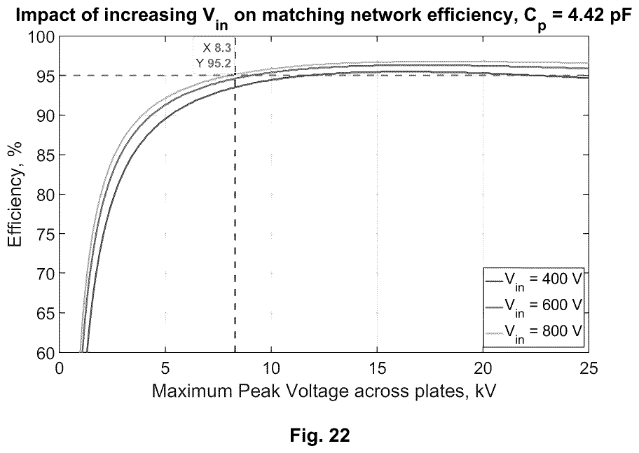

In accordance with at least some embodiments, to further enhance system efficiency, a viable strategy may be to increase the system input voltage. Of note, a higher input voltage results in a reduced current step-down ratio from the primary-side matching network, necessitating a smaller inductance value and consequently lowering losses. FIG. 22 illustrates the impact of varying system input voltage on system efficiency by providing a plot of system efficiency with respect to peak voltage across air-gap at different values of system input voltages.

Through simulation, it is evident that, with an optimally designed pair of rectangular metacouplers, an input voltage of 800 V may surpass the 95% efficiency threshold. As a result, the method disclosed in FIG. 21 in combination with simulation affirms the efficacy of the design algorithm but also highlights the prospect of attaining heightened efficiency through deliberate design considerations.

With this understanding in mind, a description of an implementation of a rectangular capacitive metacoupler with aluminum backing plates is provided to highlight the practical implementations of the discled embodiments. More specifically, in a practical capacitive WPT system, L-section matching networks play a crucial role in providing the necessary voltage gain and reactive compensation to ensure full power transfer from the primary side to the secondary side. For enhanced system performance, two strategically positioned aluminum backing plates may be situated both above and below a pair of metacouplers, similar to the configuration found in capacitive WPT systems with conventional couplers. The dual purpose of the aluminum plate backing includes shielding the external environment from electromagnetic (EM) fields and leveraging the parasitic capacitance between the metacouplers and backing plates to serve as matching network capacitors. This integrated approach may enhance system robustness while improving the efficiency of the matching network within the capacitive WPT system.

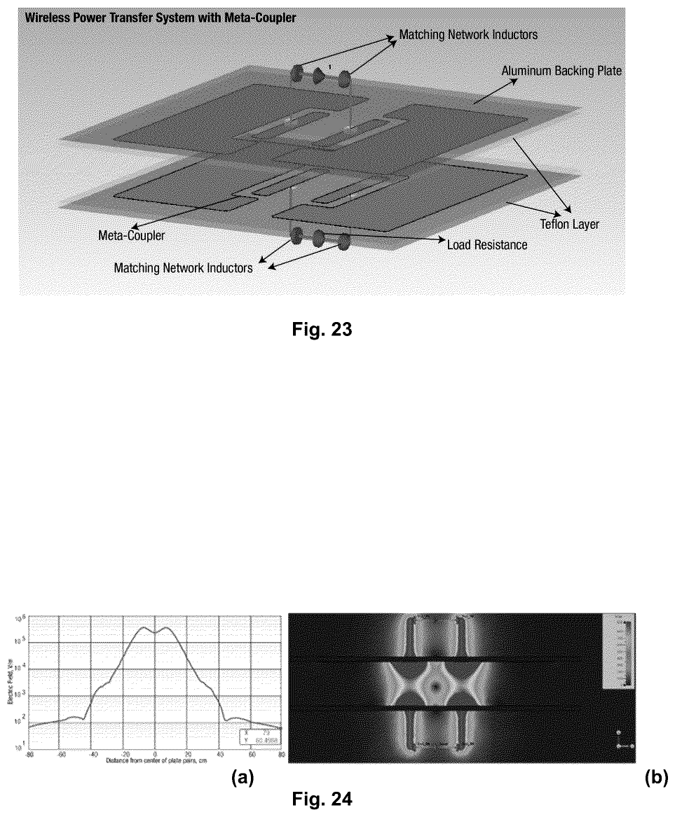

FIG. 23 shows a simulation model including a pair of metacouplers within a practical charging design i.e., with aluminum backing plates. FIG. 23 illustrates a simulation for a capacitive wireless power transfer system incorporating the optimized rectangular metacoupler design, wherein the matching network is created using ideal inductors, as well as an aluminum backing plate and a teflon layer.

As discussed with reference to other design examples previously described, a vertical separation between a pair of metacouplers remains fixed at 12 cm, while the lateral separation may be maintained at 10 cm. Each plate occupies an area of 0.165 m², deliberately chosen to achieve a power density of 150 kW/m² with an output power of 50 kW. This charging design integrates parallel capacitances for matching the input source and load resistance. The input source and the load resistance may be matched through parallel capacitances created by the teflon layer of thickness 12 mm and the aluminum backing plate, and by series inductors of 4 pH each.

FIGS. 24(a)-(b) shows the simulation of the resulting electric field when the system of FIG. 23 is operated at 50 KW, as well as a contour plot of the electric field magnitude distribution. FIG. 24(a) is a plot of the resulting electric field when the metacoupler system is delivering 50-kW. The marker at a horizontal distance of 79 cm from the center of the plate pairs highlights the electric field below the safety limit at the desired edge. FIG. 24(b) provides a contour plot of the electric field magnitude distribution in the metacoupler system. It should be noted that the electric field is concentrated towards the center of the inner plates, resulting in a strong fringing-field reduction. Further, as can be seen from FIG. 24(b), the electric field is strongly concentrated in the gap between inner conducting plates and outer C-shaped plates, which allows the system to operate with much lower fringing electric field, which is well below the safety limit of 68 V/m imposed by the ICNIRP. This realistic simulation offers evidence of the technical effect of the design enables the system to transfer power wirelessly with the presence of the aluminum backing plate and the teflon layer.

Further explanation of the experimental validation of the aforementioned design configurations performed with regards to the components, systems and methodologies is now provided for completeness of understanding. For experimental validation of rectangular metacouplers with C-shaped outer plates, two scaled prototype capacitive WPT systems operating at 13.56 MHz with a 3-cm air gap were constructed and tested. These prototypes are scaled down versions (dimensions scaled by 4) of the 50-kW design example discussed above. In this context, the first prototype utilizes a conventional pair of couplers, while the second prototype incorporates a pair of metacouplers.

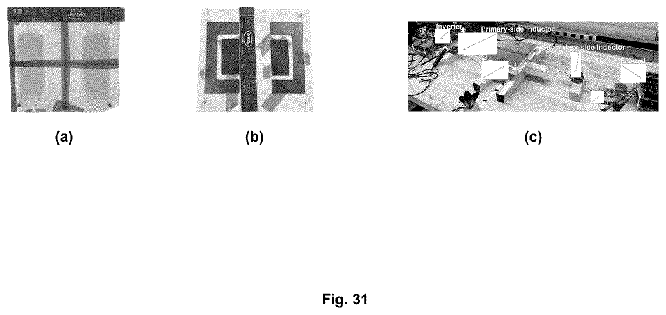

With reference to FIGS. 31(a)-(c), one can observe both the conventional pair of couplers and the implemented pair of metacouplers having C-shaped conductive plates, along with the setup of the WPT system prototype. FIG. 31(a) is a photograph of an implemented rectangular conventional coupling plate. FIG. 31(b) is a photograph of an implemented rectangular metasurface-based coupling plate. FIG. 31(c) is a photograph of a 13.56-MHz 3-cm air-gap capacitive WPT system prototype.

The traditional pair of couplers were crafted using copper plates measuring 15 cm×6.67 cm, while the pair of metacouplers have the same overall dimensions. The C-shaped conductive plates in the pair of metacouplers were designed with a 1 cm gap between the inner conductive plates and outer C-shaped plates. The inverter transistors were realized using 650-V GaN transistors, and the matching network inductors are implemented as single-layer winding Fair-rite 67 material cored toroidal inductors. It is important to note that, for a fair comparison, the inductance values used in both prototype systems were identical.

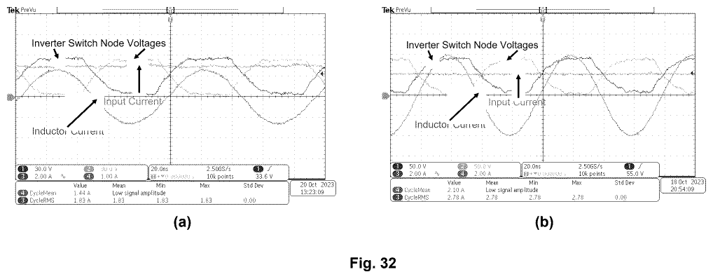

FIGS. 32(a)-(b) illustrate the measured waveforms of the inverter switch-node (SW) voltages, inverter output current, and the input dc current in the two prototype systems.

FIG. 32(a) illustrates measured waveforms of the inverter switch-node voltages, the inverter output current, and the input de current in the 13.56-MHz 3-cm air-gap capacitive WPT prototype utilizing rectangular conventional coupling plates. FIG. 32(b) illustrates measured waveforms of the inverter switch-node voltages, the inverter output current, and the input dc current in the 13.56-MHz 3-cm air-gap capacitive WPT prototype utilizing rectangular capacitive metasurface based coupling plates.

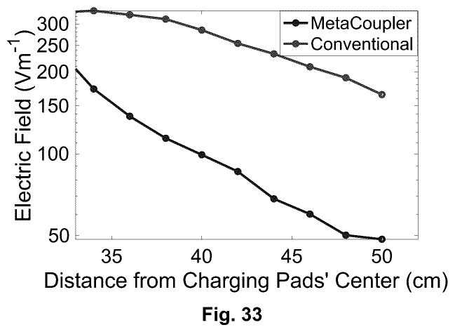

Furthermore, FIG. 33 presents the measured electric field levels in the two prototype systems such that 500 V peak air-gap voltage is developed across both the pair of couplers and metacouplers. FIG. 33 illustrates a comparison of electric field intensity levels as a function of distance from the center of the plate-pairs in the two capacitive WPT prototypes utilizing rectangular conventional couplers, and rectangular capacitive metasurface based couplers.

Of note, the field levels near the coupling plates in the metacoupler-based system were found to be 3.3 times lower than those in the conventional coupler-based system. Further, it is important to note that, for the experimental validation, the example metacoupler design was modified such that it gave a 4.5× theoretical reduction as compared to using a pair of conventional couplers. This result underscores the effectiveness of the metacoupler design with C-shaped conductive plates provided in accordance with various disclosed embodiments.

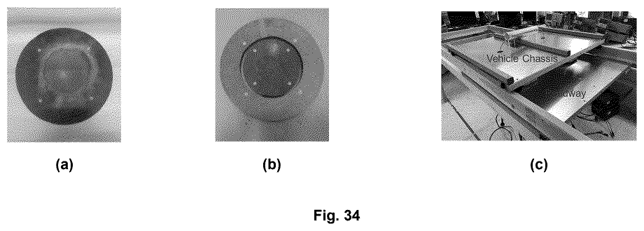

To validate the effectiveness of circular metacouplers provided in accordance with various disclosed embodiments, two 13.56-MHz 12-cm air-gap scaled prototype capacitive WPT systems were designed, built and tested. The first prototype utilized a conventional coupler while the second prototype utilized a capacitive metacoupler in accordance with disclosed embodiments. FIGS. 34(a)-(c) show the conventional coupler, the implemented metacoupler, and the prototype WPT system. More specifically, FIG. 34(a) is a photograph of an implemented conventional coupling plate. FIG. 34(b) is a photograph of an implemented metasurface-based coupling plate. FIG. 34(c) is a photograph of a 13.56-MHz 12-cm air-gap capacitive WPT system prototype.

The conventional couplers were implemented using 22-cm diameter copper plates. The metacouplers were implemented using a 12-cm diameter circular plate and a 22-cm outer-diameter copper ring placed concentrically with a 1-cm air-gap between them. The inverter transistors were realized using 650-V GaN transistors. The matching network inductors were implemented as single-layer air-core solenoids. The inductors of the two prototype systems were designed to have the same quality factor to ensure a fair comparison.

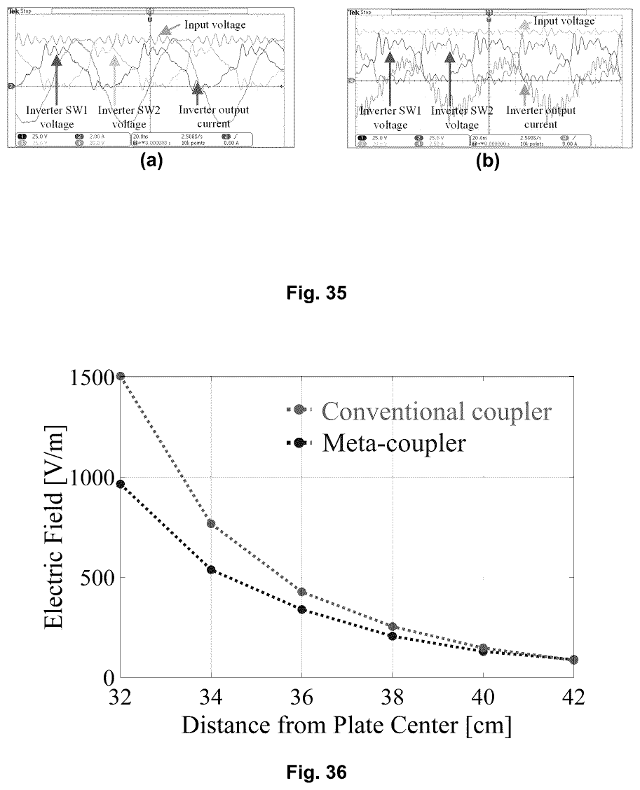

FIGS. 35(a)-(b) show the measured waveforms of the inverter switch-node (SW) voltages, inverter output current, and the input DC voltage in the two prototype systems. FIG. 35(a) shows measured waveforms of the inverter switch-node voltages, the inverter output current, and the input voltage in the 13.56-MHz 12-cm air-gap capacitive WPT prototype utilizing conventional coupling plates. FIG. 35(b) shows measured waveforms of the inverter switch-node voltages, the inverter output current, and the input voltage in the 13.56-MHz 12-cm air-gap capacitive WPT prototype utilizing capacitive metasurface based coupling plates.

The measured electric field intensities in the two prototype systems while operating at 50 W output power are shown in FIG. 36. More specifically, FIG. 36 illustrates a comparison of electric field intensity levels as a function of distance from the center of the plate-pairs in the two capacitive WPT prototypes utilizing conventional couplers, and capacitive metasurface based couplers.

Of note, the field levels in the vicinity of the coupling plates in the metacoupler-based system are 40% lower than those in the conventional-coupler-based system, validating the effectiveness of the metacoupler configuration of various disclosed embodiments.

In accordance with various embodiments, the metacouplers may be placed within two elongated metal sheets separated by a distance creates a waveguide, which aids significantly in field reductions in capacitive WPT systems.

As previously described, in a practical capacitive wireless power transfer system two metal backing plates may be placed above and below the metacouplers. If the length of each metal plate is extended significantly beyond the charging pad, the electric field emanating from the system decays in an exponential manner, as opposed to the expected cubic decay for such a dipole-like system. Since the two metal plates are above and below the metacouplers, the system resembles a parallel plate waveguide. In such a structure, regardless of wave polarization, if the frequency of the wave is below that of the cut-off frequency of the waveguide, exponential decay of the electric field results. The cutoff frequency is given by:

$${ω}_{cutoff} = {c}_{o} ( \frac{m π}{d} )$$

where m is an integer representing the mode number and d is the spacing between the metal plates. As an example, if the separation of the metal plates is set to, e.g., 19.7 cm, the cut-off frequency for the first order mode (m=1) would be 761.42 MHz. In this example, the structure may be simulated at its operational frequency of 13.56 MHz; since that frequency is well below the cut-off frequency of the simulated waveguide, the fields are expected to behave as part of an evanescent wave, whereby the fields decay exponentially. The expected exponential decay coming from the waveguide varies with the constant α, which can be calculated as follows:

$$a = \sqrt{\vert {ω}^{2} {ϵ}_{o} {μ}_{o} - {( \frac{m π}{d} )}^{2} \vert}$$

With this understanding of the validation of the technical utility in mind, returning to FIG. 25 a plot of electric field decay for couplers between aluminum plates compared to the exponential decay of evanescent fields inside a parallel-plate waveguide under cutoff is provided. More specifically, in FIG. 25, a CST Microwave Studio simulation result is shown for the electric field emanated by the couplers when placed in the waveguide. For reference, cubic decay is also shown. An exponential decay curve with the expected a for the specific waveguide system (red-dashed line) as well as a cubic decay curve for a dipole-like system (yellow-dashed line) is superimposed on the graph. As can be seen, the blue line showing the electric field decay agrees with the predicted exponential decay of a parallel plate waveguide operating under cutoff. From this plot, it is, therefore, evident that adding a parallel plate waveguide to the system can greatly reduce the fringing electric fields due to its faster electric field decay compared to a conventional cubic decay that would govern the electric fields if the waveguide was not present.

Of further note, as one moves closer to the termination of the waveguide (or the end of the metal plates), the exponential decay of the electric fields appears to slow down. Since the impedance of the wave inside the waveguide is purely imaginary (while impedance of free space is purely real), at the interface of the two, there should be reflections that can change the electric field shape inside the waveguide. Therefore, to obtain the highest possible electric field reduction, the parameters of the waveguide may be varied, e.g., length and/or width to impact the wave impedance inside the waveguide, thereby varying the electric field decay/rise close to the edge of the metal plates.

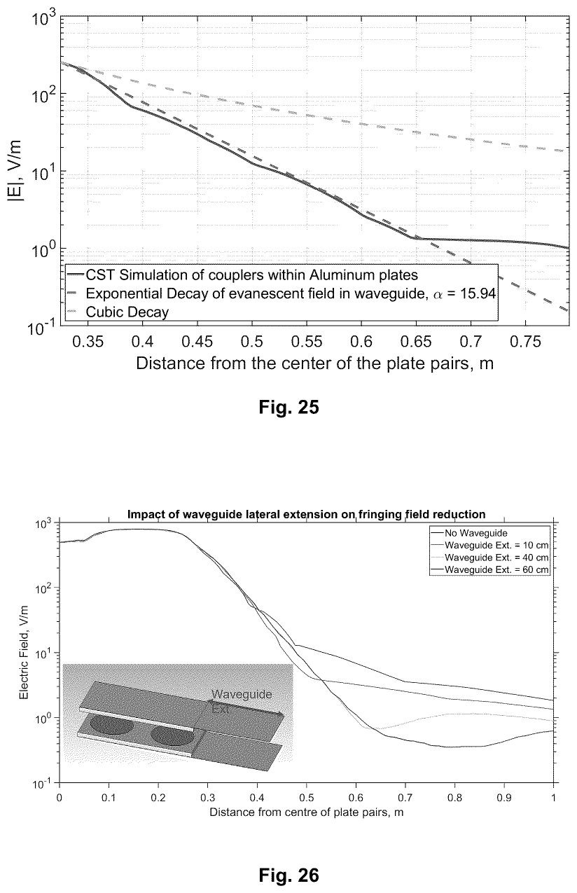

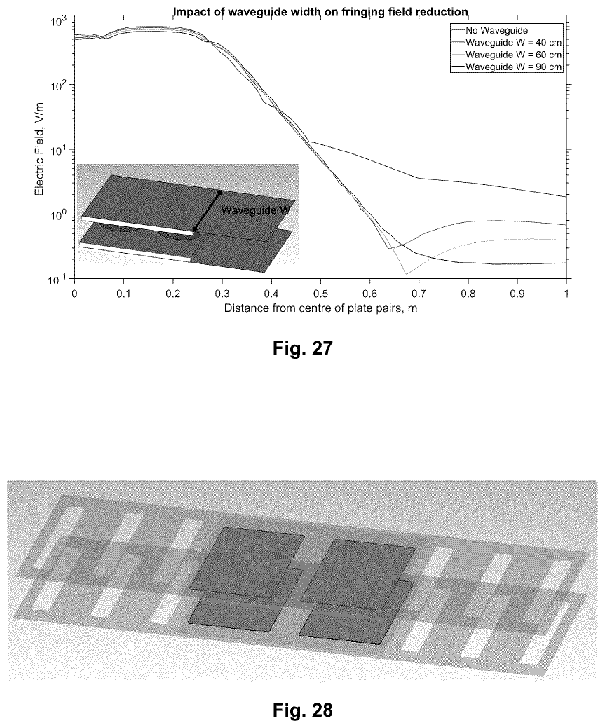

In FIG. 26 and FIG. 27, the design impact of varying the length and width of the waveguide on the fringing electric fields is simulated. FIG. 26 illustrates a plot of electric field decay for metacouplers positioned between aluminum plates i.e., within a waveguide, wherein the effect of different lengths of waveguide may be compared. FIG. 27 illustrates a plot of electric field decay for metacouplers positioned between aluminum plates, i.e., within a waveguide, wherein the effect of different widths of waveguide may be compared.

Yet another potential approach to design of a waveguide metacoupler structure in accordance with the disclosed embodiments is to vary the waveguide impedance as shown in FIG. 28. In this approach, cutouts of arbitrary length and width may be positioned to impact the characteristic impedance of an evanescent mode inside the waveguide. Thus, FIG. 28 illustrates an example of a capacitive WPT charging system with conventional couplers using cutouts in the extended aluminum plates of the parallel plate waveguide structure to shape electric field decay.

Theoretically, by using such cut-outs, the reflections coming from the waveguide termination may be impacted such that the electric field decay is maximized.

With this understanding of various structural design considerations of the waveguide approach to reducing fringing fields in mind, it should be understood that fringing field reduction utilizing metacoupler and waveguide phenomena are particularly beneficial in capactive WPT systems. More specifically, in applications such as high-power (few tens of kilowatts) EV charging utilizing capacitive WPT systems, the need for a significant reduction in fringing fields to comply with electric field safety limits is crucial. However, relying solely on metacouplers for achieving the desired fringing field reduction may not be an optimal solution due to the necessity of a substantially smaller inner plate area compared to the outer plate or ring area, resulting in a reduction of coupling capacitance. Still further, while the waveguide effect can expedite the decay of electric fields without compromising coupling capacitance, it may not be independently adequate for achieving desired field reductions. Thus, combining both metacoupler and waveguide approaches described above proves to be an efficient strategy (forming a “waveguide-metacoupler”), because the overall fringing field reduction can be distributed between these methods, thereby not compromising on coupling capacitance excessively.

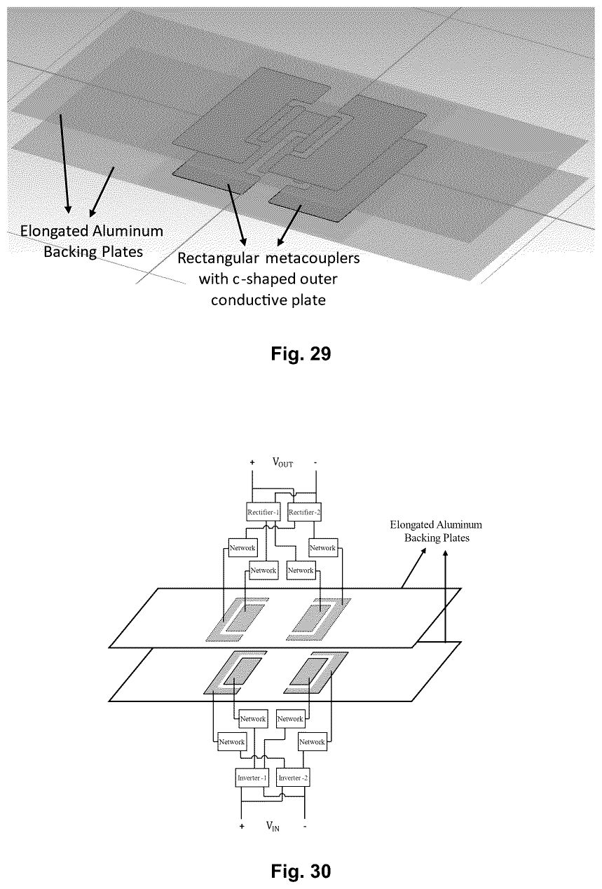

FIG. 29 illustrates one such waveguide-metacoupler implementation, featuring rectangular metacouplers with C-shaped outer conducting plates backed by elongated aluminum plates. Thus, FIG. 29 illustrates an example of a capacitive WPT system utilizing rectangular metacouplers with c-shaped outer rings and waveguide structure formed by elongated aluminum backing plates to achieve significant field reductions efficiently.

In this regard, charging utilizing capacitive WPT systems that include a waveguide metacoupler structures according to the disclosed embodiments offer a significant reduction in fringing fields to comply with electric field safety limits.

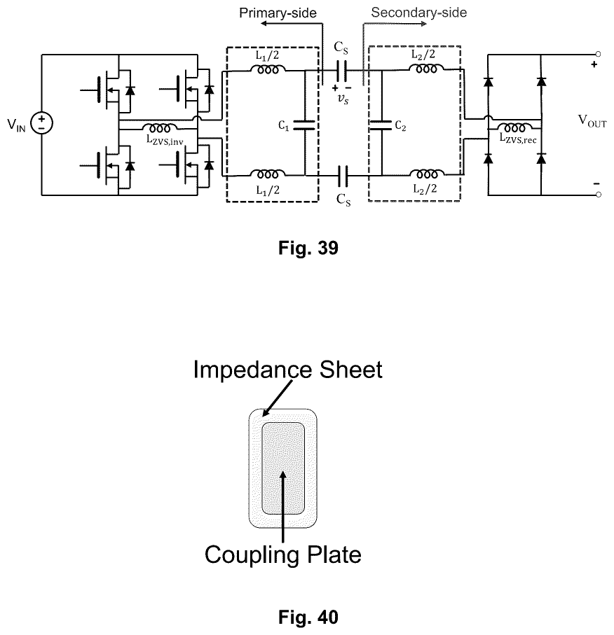

Turning to another implementation example, FIG. 39 shows an exemplary architecture of a capacitive WPT system for mobile robot charging application provided in accordance with the disclosed embodiments. FIG. 39 illustrates a topology of a capacitive WPT system with single-stage L-section matching networks. A full-bridge inverter on the primary side converts the DC input voltage to a high-frequency AC voltage. Typically, high frequency inverters in a capacitive WPT system are implemented as full bridge class-D inverters because of the higher transistor utilization factor compared to other classes of inverter topologies. This voltage may be stepped up by an L-section matching network. Thus, a high voltage is developed across the pair of couplers that enables high power transfer with a relatively small displacement current through the air-gap. This results in relatively low fringing electric fields outside the coupler. On the secondary-side, the displacement current is stepped up by another L-section matching network to the level required to charge robot's battery. Finally, at the output stage, high-frequency rectifier converts the output of the matching network to a DC voltage to charge up the battery. The matching networks fully compensate the capacitive reactance of the couplers, therefore, the net impedance seen by the inverter is resistive, which effectively minimizes circulating currents. Also, auxiliary Zero Voltage Switching (ZVS) inductors may be used for soft-switching of inverter and rectifier transistors.

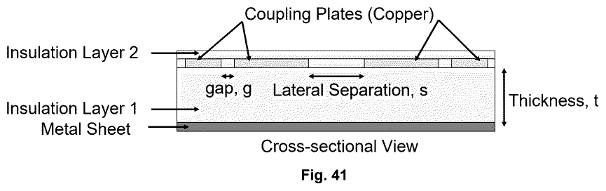

With this understanding of a practical implementation of the disclosed embodiments in mind, further details regarding a methodology to design metasurface-based capacitive couplers that reduce the fringing electric fields in these capacitive WPT systems is provided to maximize the overlap time between charging pads for the primary and secondary-side illustrated in FIG. 39. As discussed above with reference to FIGS. 7(a)-7(b) and 11, metacouplers maybe introduced that utilize distributed (lumped) impedance sheets to reduce the fringing electric fields. FIG. 40 provides a conceptual metasurface-based coupling plate in this regard. Such impedance sheets can be designed to be either inductive or capacitive in nature. Implementing a capacitive metasurface is relatively simpler to implement since loaded capacitors can be realized by just introducing an air-gap through a metallic ring around the coupling plate.

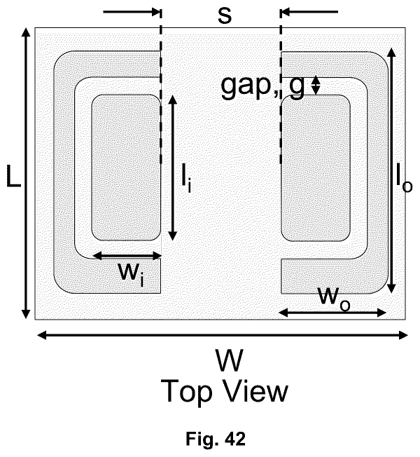

FIGS. 41 and 42 show the cross-sectional and top view of one novel implementation of metasurface-based charging pads, respectively. FIG. 41 shows a cross-sectional view of the proposed charging pad (Cross-section of one side. The other side is identical).

FIG. 42 provides a top view of the proposed charging pad. Unlike various conventional designs, the structure according to the disclosed embodiments may use only a semi ring around the inner coupling plates, instead of having a full metallic ring. This implementation is derived from the fact that only the fringing electric fields outside charging pads need to be restricted. This design offers several advantages for the system. By eliminating one half of the ring structure, it increases the available area for the inner plate, leading to a greater coupling capacitance. Consequently, this enhancement results in higher system efficiency. Additionally, this approach is cost-effective and simplifies the modeling process, making it more feasible and practical for implementation.

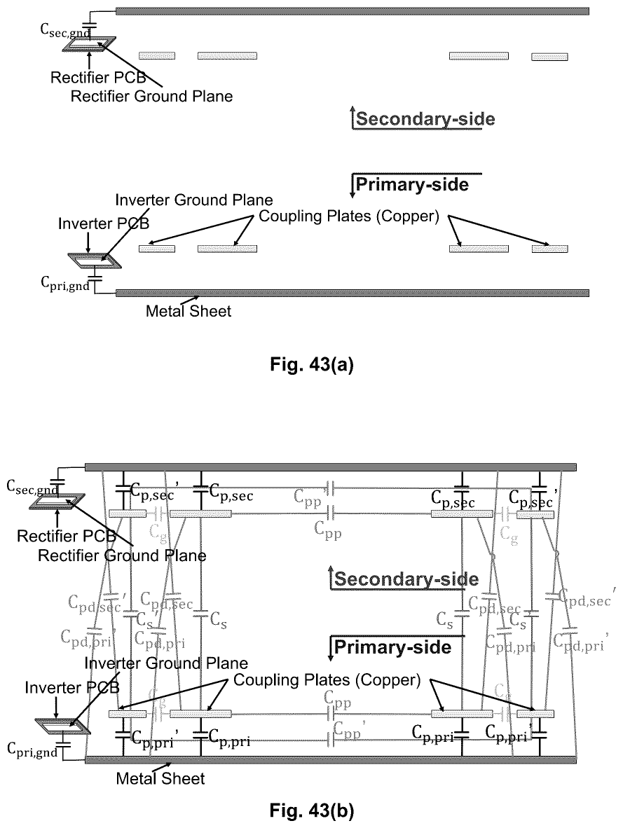

In a practical charging scenario, apart from the intended capacitance between the coupling plates (Cₛ), the system may exhibit additional parasitic capacitances. These parasitic capacitances arise from the cross-coupling between the plates, also referred as diagonal capacitances, the coupling between two plates on the same side (Cₚₚ), the coupling between the plates and the primary-side metal sheet (C_{p,pri}, C_{p,pri} and C_{pd,pri}), the coupling between the plates and the secondary-side metal sheet (C_{p,sec}, C_{p,sec} and C_{pd,sec}), and the capacitances between inner and outer plates (C_{g}) of the proposed metacoupler. Many of these parasitic capacitances are comparable or even higher in magnitude (e.g., C_{g}) than the desired coupling capacitance Cₛ, therefore, cannot be ignored. Also, capacitance C_{pri,gnd} arises from the proximity between primary-side metal sheet and inverter PCB ground. Similarly, capacitance C_{sec,gnd} arises from proximity between secondary-side metal sheet and rectifier PCB ground. Usually, the metal sheets and onboard power electronics are close to each other, therefore, C_{pri,gnd} and C_{sec,gnd} cannot be ignored. FIGS. 43(a)-(b) show the coupling and parasitic capacitances of the system, wherein a cross-sectional view of both the primary-side and secondary-side charging pads separated by an air-gap illustrated, with insulation layers not showed for clarity.

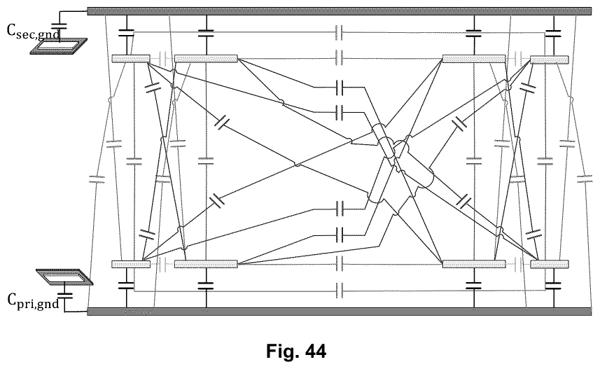

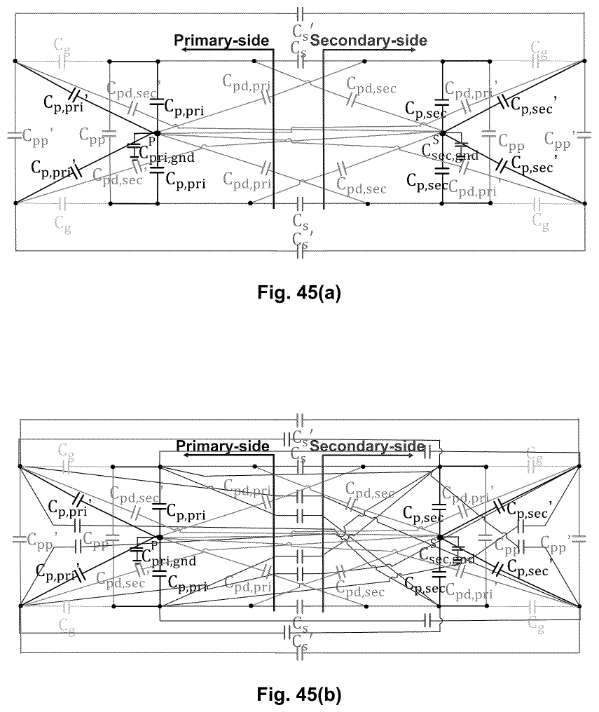

FIG. 43(a) is an illustrative diagram for a practical charging scenario for a mobile robots' charging. FIG. 43(b) incorporates parasitic capacitances for the concept shown in FIG. 43(a) except diagonal capacitances (for clarity). FIG. 44 illustrates a complete physical model of the couplers with parasitics. The cross-coupling capacitances between every plate are highlighted in red. FIG. 45(a) illustrates an equivalent electrical model of the system with parasitics (diagonal capacitances not shown for clarity). FIG. 45(b) illustrates a full equivalent electrical model of the system with all parasitic capacitances.

Designing the matching networks for the capacitive WPT system in FIG. 45(a) presents considerable challenges in achieving the desired power transfer. Consequently, there arises a need to simplify the high-order capacitive network into a more workable equivalent model. It is conventionally understood that that the circuit symmetry enforced by splitting the matching network inductors prevents parasitic currents to flow through C_{pri,gnd} and C_{sec,gnd}. Furthermore, this symmetry ensures the coupling between metal sheets and plates (i.e., C_{p,pri}, C_{p,pri}, C_{pd,pri} and C_{p,sec}, C_{p,sec}, C_{pd,sec}) to be in series with each other, hence, resulting in

$$\frac{{C}_{p . , ri}}{2} , \frac{{C}_{p , pri}^{′}}{2} , \frac{{C}_{pd , pri}}{2} and$$

$$\frac{{C}_{p , s ec}}{2} \frac{{C}_{p , s ec}^{′}}{2} \frac{{C}_{pd , s ec}}{2} .$$

These capacitances effectively come in parallel with Cₚₚ and Cₚₚ ∝.

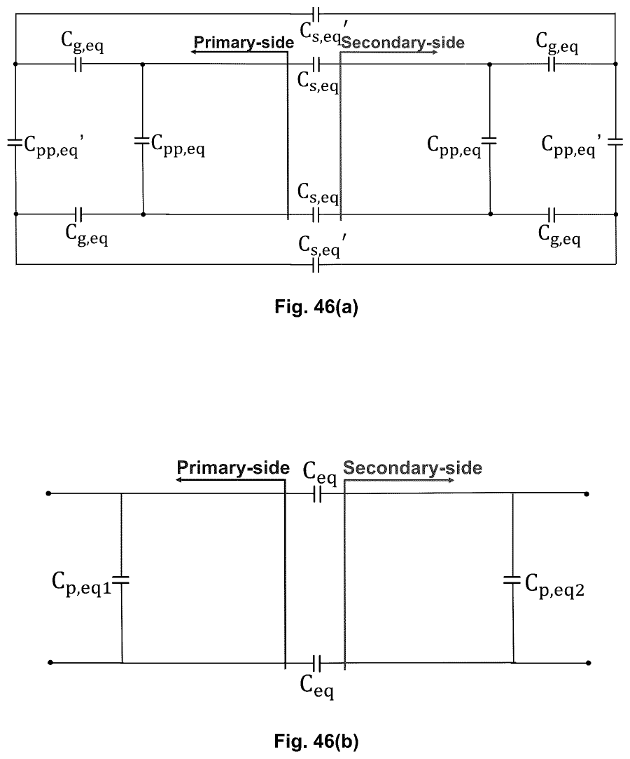

FIG. 46(a) shows an intermediate stage in simplifying this high-order capacitive network, wherein an equivalent circuit model is shown after split inductor symmetry and incorporating diagonal capacitances. Here, C_{pp,eq}, C_{pp,eq}′ are equivalent capacitances after simplification aided from split inductor symmetry. Furthermore, C_{g,eq}, C_{s,eq} and C_{s,eq}′ are effective equivalent capacitances after incorporating the cross-coupling diagonal capacitances, using conventionally known two-port network theory. A detail of this simplification is illustrated in the Appendix.

With the aid of T and Pi-transformations, the circuit in FIG. 46(a) can be simplified to a four-capacitance model shown in FIG. 46(b). This result enables more effective and simplified design of matching networks in the metasurface-based WPT system of the disclosed embodiments.

With the simplified four-capacitance model of the required matching networks in mind, the desired effective coupling capacitance between primary and secondary side may be determined using conventionally known capacitance tests. Returning to the cross sectional view of FIG. 41, the thickness of the insulation layer 1, t in the charging pad can be selected to realize the desired matching network capacitance. Teflon, having dielectric strength double than that of air and high tensile strength may, for example, be chosen as the insulation layer.

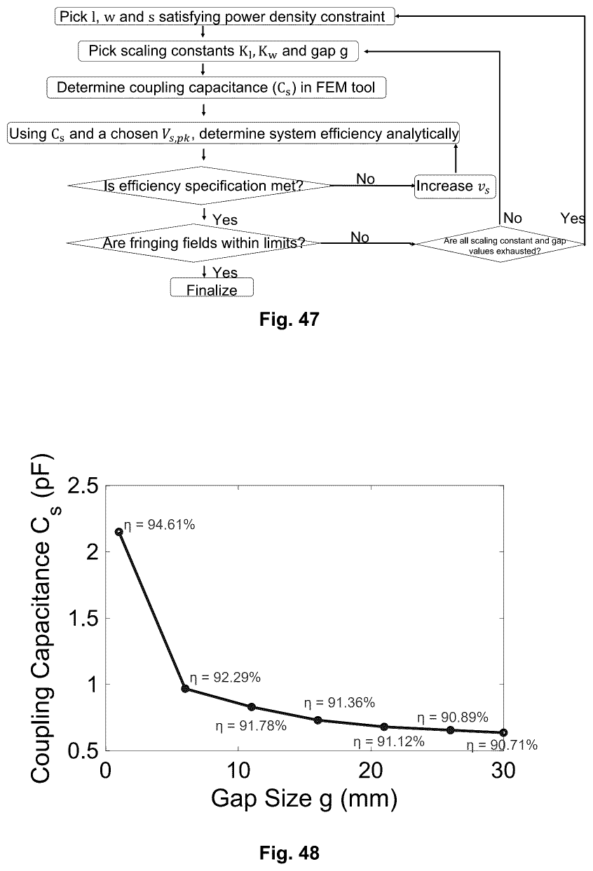

FIG. 47 presents an exemplary methodology employed to design capacitive WPT system for desired target specifications at chosen input (V_{IN}) and output (V_{OUT}) voltages in accordance with the disclosed embodiments. More specifically, FIG. 47 illustrates an example of a summary of optimization methodologies to pick metasurface-based coupling plates dimensions while being efficient, within electric field safety limits and satisfying a power transfer density constraint. The process involves selecting the outer length (lₒ) and width (wₒ) of the coupling plates to meet the total coupling plate area requirement and achieve the desired power transfer density (2lw=P_{OUT}/P_{d}). Lateral spacing(s) between the plates in each charging pad and the gap (g) between the inner plate and outer ring are also chosen.

Subsequently, the inner copper plates' dimensions are scaled with a scaling constants defined as Kₗ=lᵢ/lₒ for length and K_{w}=wᵢ/wₒ for width. Thereafter, for, e.g., typical ground clearance of mobile robots (˜3-5 cm), coupling capacitance Cₛ of the system may be determined using a Finite Element Method (FEM) tool for the picked dimensions.

Based on the coupling capacitance, matching networks for the WPT system may be designed using an analytical approach, starting with a predefined low value for the peak voltage across the coupling plates (V_{s,pk}). The overall system efficiency may then be evaluated, and if the target efficiency is not met, the peak voltage may be increased incrementally until the desired efficiency is achieved. Once the efficiency specification is met, fringing electric fields may be measured using the FEM tool to ensure they fall within specified safety limits. If the fields are within the limits, the dimensions of the coupling plates may be finalized. Otherwise, scaling constants Kₗ, K_{w} may be decreased and the gap (g) may be adjusted. This iterative design process may continue until the fringing fields are within the required safety limits.

To illustrate the real world impact of the gap size (g) between the inner and outer ring, as well as the scaling constants Kₗ and K_{w}, on the fringing electric field, discussion of multiple simulated designs and their comparison with a set of conventional couplers is now provided. The introduction of the gap (g) between the inner and outer plates (or rings) focuses electric fields within this gap, thereby, reducing the fringing electric fields outside the metacouplers. However, it reduces the overall coupling capacitance between the ground and the secondary side as it introduces a series capacitance. Reduction of the coupling capacitance implies that a larger inductor is needed to compensate for the coupling reactance, thus, increasing the losses. Therefore, it is natural to observe a reduction in efficiency of the WPT system with the increase in gap size (g). This exhibits a clear tradeoff between the reduction of fringing fields and the WPT system's efficiency.

FIG. 48 illustrates a variation of coupling capacitance Cₛ of the metacouplers with increasing gap (g) between inner plate and outer ring. Matching network efficiency is highlighted for each point. FIG. 49 plots fringing electric fields for various gap sizes (g), thereby illustrating the impact of increasing the gap size on fringing electric fields. The greater the gap size, the greater will be the reduction in electric fields; however, this result comes at the expense of efficiency.

Of note, the impact of variation in scaling the inner plates with respect to the outer plates should be intuitive. Smaller inner plates, and larger outer rings imply a large series capacitance between the two. This dominant series capacitance causes fringing electric field levels to drop outside the metacouplers. Additionally, the smaller the inner plates, the lower the coupling Cₛ between the primary and secondary sides.

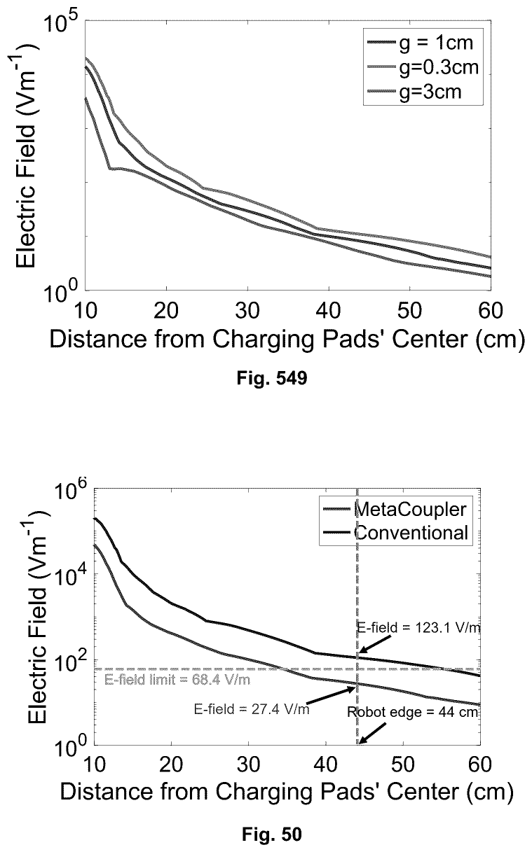

Using the methodologies discussed above, a 13.56-MHz 3-cm air-gap 1.5-kW metacoupler-based capacitive WPT system may be designed to meet a target efficiency that is at least greater than 90% and power transfer density of 75 kW/m². Using the methodology presented in FIG. 47, with 300 V as the specified input and output voltage, the dimensions of the rectangular coupling plates may be finalized and the minimum peak voltage across the coupling plates (V_{s,pk}) may be 2 kV. Accordingly, FIG. 50 plots simulated electric fields after applying 2 k V across coupling plates on FEM tool is within electric field safety limits, by using metacouplers as compared to conventional couplers. It should be evident from FIG. 50 that given V_{s,pk} of 2 kV, the metacoupler design is within electric field safety limits. At 44 cm, noting that the track width of a target ABB AMR P404 mobile robot is ˜88 cm from the center of charging pads, the metacoupler simulation achieves 4.5× reduction in electric fields.

Table I shows the physical dimensions while Table II shows the matching network values for the designed 13.56-MHz 3-cm air-gap 1.5-kW capacitive WPT system using metacouplers.

TABLE I
PHYSICAL DIMENSIONS OF THE DESIGNED
CHARGING PADS USING METACOUPLERS

| | | | | | | Charging | Charging |
|---|---|---|---|---|---|---|---|
| | | Lateral | | Length | Width | Pad Total | Pad Total |
| Length, | Width, | Separation, | Gap size, | Scaling | Scaling | Length, L | Width, W |
| l (cm) | w (cm) | s (cm) | g (mm) | constant K₁ | constant K_{w} | (cm) | (cm) |
| 15 | 6.875 | 7 | 10 | 0.5 | 0.525 | 22 | 24 |

TABLE II
NETWORK VALUES FOR DESIGNED SYSTEM

| | | Secondary- | Secondary- | |
|---|---|---|---|---|
| Primary-side | Primary-side | side | side | Coupling |
| Inducatance, | Capacitance, | Inducatance, | Capacitance, | Capacitance, |
| L₁(μH) | C₁(pF) | L₂(μH) | C₂(pF) | Cₛ(pF) |
| 17.05 | 8.1 | 17.05 | 8.1 | 0.84 |

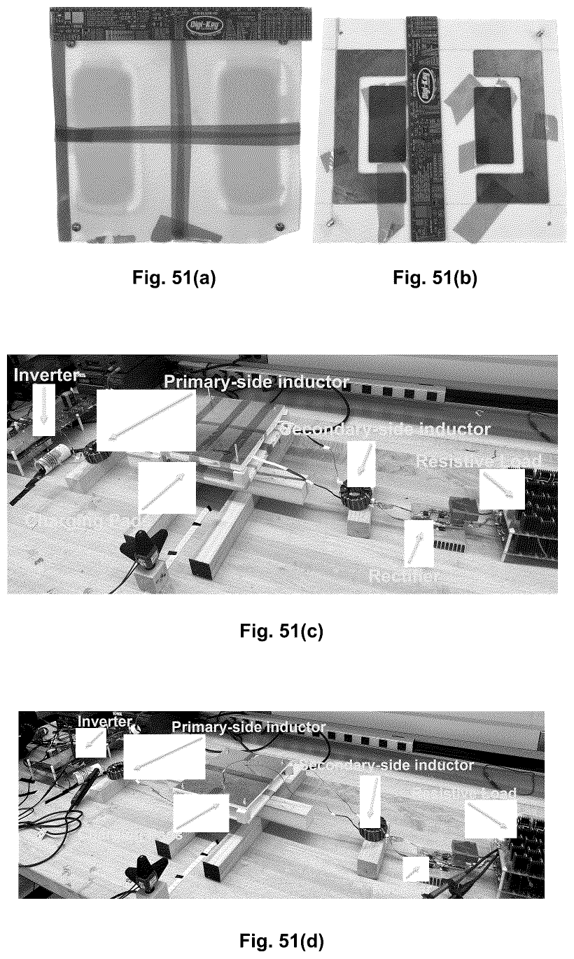

To experimentally validate this particular metacoupler design provided for a mobile robot charging application, two systems were built: one using conventional couplers and the other using metacouplers designed in accordance with the disclosed embodiments. FIG. 51(a) is a photograph of conventional couplers. FIG. 51(b) is a photograph of the capacitive metacoupler designed in accordance with the disclosed embodiments. Likewise, FIG. 51(c) is a photograph of a capacitive WPT experimental prototype using conventional couplers and FIG. 51(d) is a photograph of a capacitive WPT experimental prototype using metacouplers designed in accordance with disclosed embodiments.

Of note, for implementation comparison, it should be recognized that both the conventional system and the metacoupler designed system have similar dimensions, similar matching networks and operate at 13.56 MHz with a 3-cm air-gap and 1.5-kW output power. Matching network inductors were implemented using single-layered Fair Rite Material-67 cores. GS66516T 650-V GaN FETs and 650-V STPSC12065 Schottky diodes were used as inverter transistors and high-frequency rectifiers, respectively. A 1μH single layered solenoid air cored inductor was used as the ZVS inductor. GS66516T 650-V GaN FETs were used as inverter transistors. On the secondary-side, 650-V STPSC12065 Schottky diodes were used in the high frequency rectifier and wideband resistors were used to emulate a battery. An HI-6005 electric field probe was employed for electric field measurements. As high electric field levels can damage the triaxial probes, both prototypes were operated at low power (˜70-W) to measure electric fields.

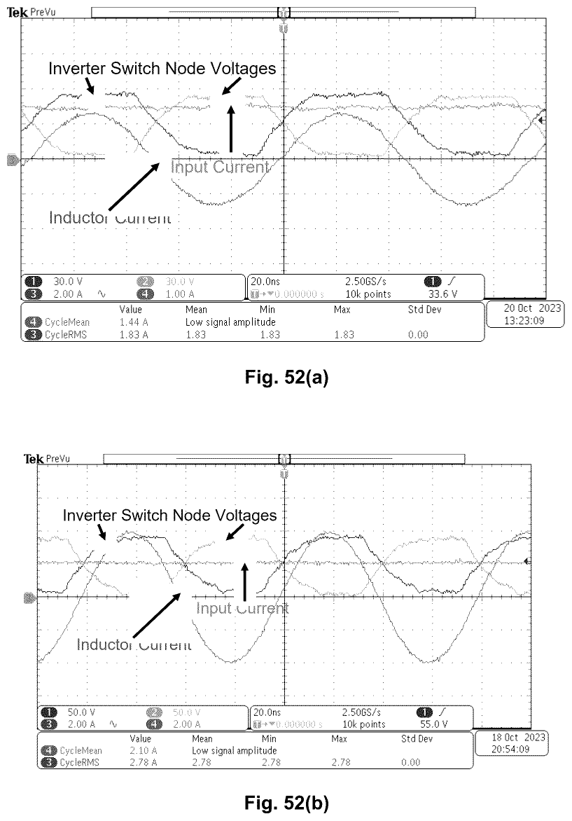

FIGS. 52(a)-(b) show the measured switch-node waveforms for both WPT systems operating at 500 Vₚₖ air-gap voltage. Also, from FIGS. 52(a)-(b), it can be seen from smooth transitions of the switch node voltages that the inverter transistors are achieving ZVS. FIG. 52(a) plots input, inductor currents and inverter switch-node voltages for WPT prototype using conventional coupler. FIG. 52(b) plots input, inductor currents and inverter switch-node voltages for WPT prototype using metacoupler structures designed in accordance with the disclosed embodiments.

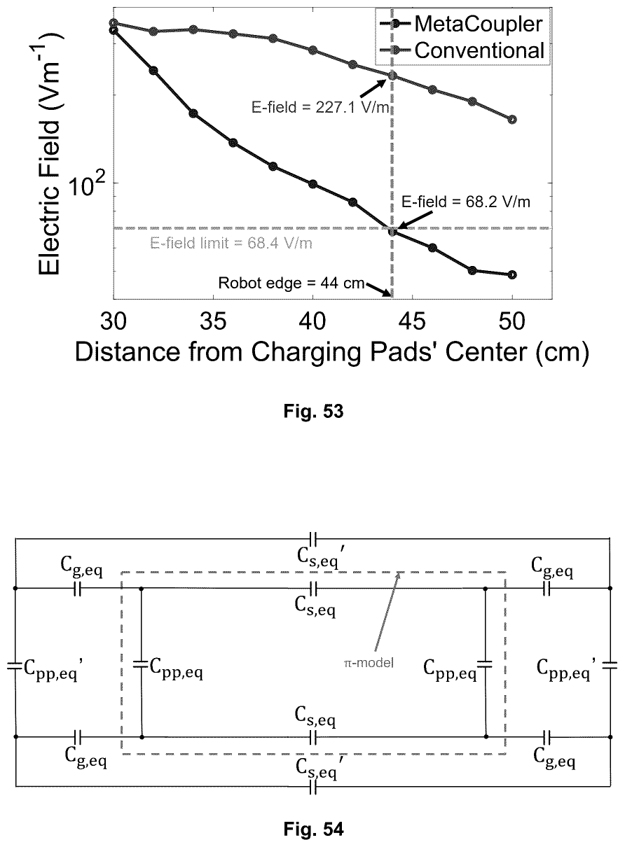

Of further note, FIG. 53 shows the measured electric fields for both the conventional coupler configuration and the metacoupler configuration, when 2 kVₚₖ is developed across the coupling plates (electric fields are measured experimentally with 500 Vₚₖ, then scaled linearly to get 2 kVₚₖ). It is shown that the experimentally measured electric fields of the metacoupler implementation are within safety limits at our desired distance of 44 cm from the charging pads' center. At this distance, the experimental metacouplers achieve an electric field reduction of 3.3× as compared to conventional coupler implementation. Although the measured electric fields are within limits, it should be noted that they are higher than the simulated setup. This can be attributed to the variations in matching network capacitances which are not realized ideally as in simulations. Also, the HI-6005 electric field probe width (˜2.54 cm) is comparable to the system's air-gap. Therefore, this may introduce an error in accuracy of the measurements as compared to simulations which are modelled under ideal conditions.

With this understanding of the design considerations relevant to effective metacoupler based WPT charging in mind, it can be seen that a high-power density capacitive WPT system may be designed with reduced fringing fields, particularly for wirelessly charging mobile robots using metacouplers to meet target specifications for fringing electric fields, system efficiency, output power, and power transfer density.

While multiple exemplary metacoupler based WPT designs have been discussed with reference to EV charging and mobile robot real world implementations, it should be understood that the technical utility of the metacoupler designs and design protocols disclosed herein are not limited to those applications.

Thus, to summarize this aspect of the disclosed embodiments, it should be understood that a metacoupler may be configured as shown in FIGS. 60(a)-(d). As shown there, the metacoupler may include a first conductive plate, a second conductive plate coupled to the first conductive plate, a third conductive plate laterally adjacent to one of the first or the second conductive plates on at least one side of the first or the second conductive plate, an input terminal connected to the first conductive plate, and an output terminal connected to the second conductive plate.

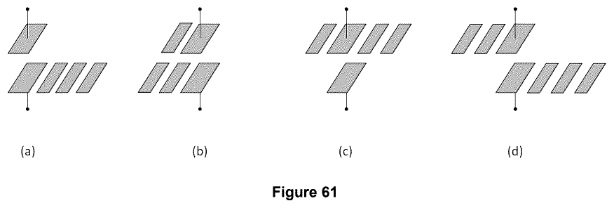

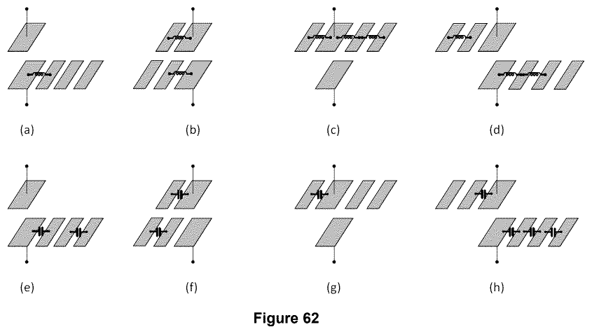

As illustrated in FIG. 61(a)-(d), there are various options for how conductive and laterally adjacent plates may be oriented relative to one another. Note that a plurality of additional conductive plates can be adjacent to the second plate in addition to the first and the third plate. As illustrated in FIGS. 62(a)-(h), at least one pair of laterally adjacent conductive plates may be connected using at least one lumped impedance element.

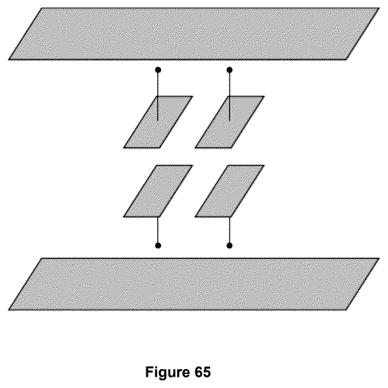

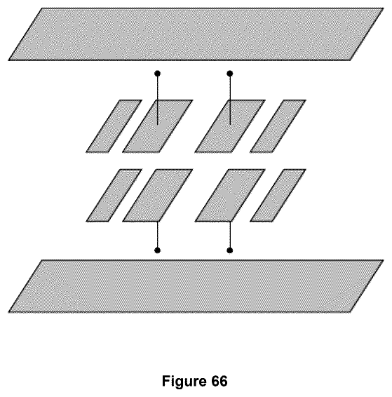

Further, with reference the various exemplary metacoupler structure designs, it should be understood that such structures may be implemented in conjunction with structure forming a waveguide so at to produce a waveguide-metacoupler structure in accordance with the disclosed embodiments. Thus, to summarize this aspect of the disclosed embodiments, it should be understood that a waveguide-metacoupler structure may be configured as shown in FIG. 65. In that exemplary implementation, a waveguide-coupler structure may include a first pair of conductive plates connected to an input port, a second pair of conductive plates connected to an output port, wherein the first and second and pairs of conductive plates are separated from each other by a gap, wherein the first and second pairs of conductive plates are placed within a waveguide structure formed by a pair of elongated conductive plates. Likewise, as shown in FIG. 66, the waveguide-metacoupler structure may be implemented using the two metacouplers capacitively coupled together as shown in FIG. 64.

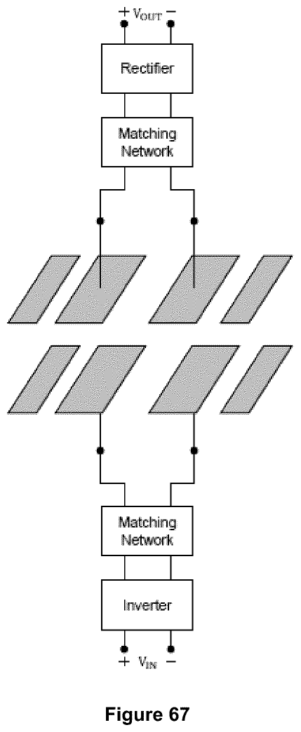

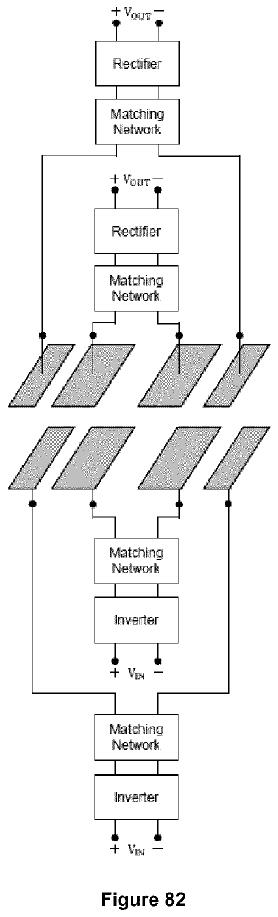

Further, it should be understood that a capactive wireless power transfer system may be configured as shown in FIG. 67, wherein the input terminals of the two metacouplers are connected to the output port of an inverter through a first matching network and the output terminals of the two metacouplers are connected to the input port of a rectifier through a second matching network. In this way the metacouplers may be driven by the inverter/matching network pair and loaded by the matching network/rectifier pair. Note, in this configuration, the laterally adjacent plates remain unconnected (as distinguished from the configuration discussed herein with reference to FIG. 82, herein).

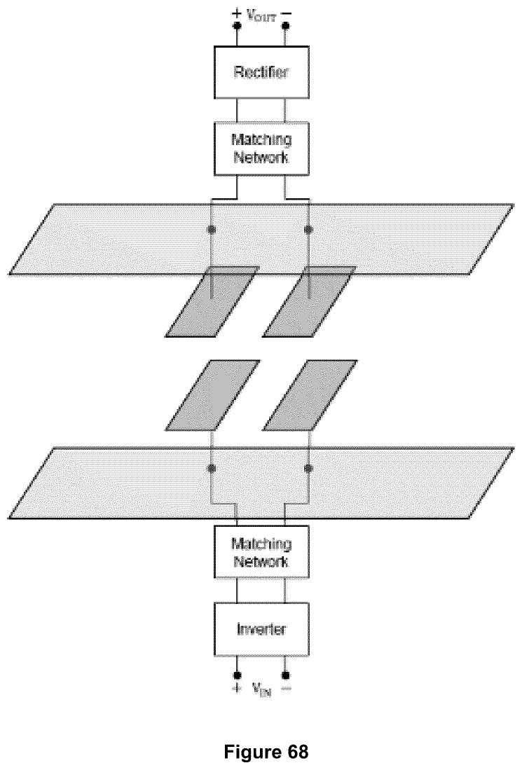

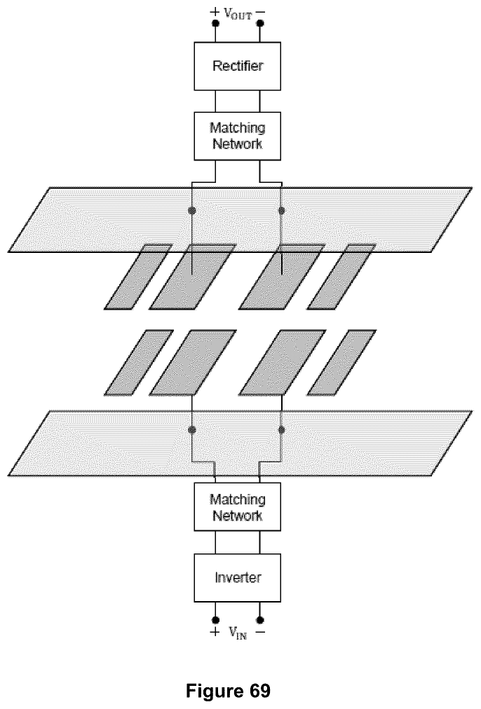

As shown in FIG. 68, the capacitive wireless power transfer system may also employ the waveguide metacoupler structure as described with reference to FIG. 61. As shown in FIG. 69, the plates used to implement the waveguide structure may be elongated to encompass additional laterally positioned plates as described with reference to FIG. 66.

With this understanding of the technical utility of the disclosed metacoupler configurations, alone and in combination with a waveguide construction, and when paired with appropriately designed matching networks, it should be appreciated that there are still further approaches to further reducing the presence and effect of fringing electric fields that may be incorporated to provide WPT charging in various real world applications.

For example, in accordance with various embodiments, outer plates of the metacoupler structures may also be used for power transfer and may be driven by a second inverter operating at approximately 180° phase-shift with respect to a first inverter, resulting in active field cancellation outside the metacouplers.

Thus, active fringing field reduction utilizing metacoupler and waveguide Phenomena may be implemented in this way. For context, it should be understood that, in very high-power EV charging applications (e.g., those exceeding 50 kW), passive fringing field reduction approaches discussed above and employing both metacoupler and waveguide techniques may prove inadequate due to undesirably low coupling capacitances arising from a significantly smaller inner plate compared to the outer plate or ring in the metacoupler structure.

To address this technical problem and its associated charging limitations, outer plates in the metacoupler structure can also be leveraged for power transfer with the help of another set of WPT system components (i.e., inverter, matching networks and rectifier) as shown in FIG. 30.

More specifically, FIG. 30 illustrates an example of a capacitive WPT system utilizing an active fringing field reduction approach with rectangular metacouplers where outer C-shaped plates are also used for power transfer with the help of another set of WPT system components (i.e., inverter, rectifier and matching networks).

In this implementation, inverter-1 and inverter-2 are operated with approximately 180° phase-shift, resulting in active field cancellation outside the metacouplers. The metacouplers may also be placed within the elongated aluminum plates to take advantage of exponential decay of electric fields due to the above-described waveguide effect, thereby resulting in overall substantial fringing field reductions.

In further detail, one inverter drives the inner plates and the other driving the outer plates of the metacoupler structure to enable operating with approximately 180° phase-shift between each other. This controlled deliberate configuration and operation results in active field cancellation outside the metacouplers. The rectifier outputs of the two WPT networks are paralleled and connected to the same load as depicted in FIG. 30. This active approach, combined with the waveguide effect generated by elongated aluminum backing plates, can achieve substantial fringing field reductions in a highly efficient manner.

As explained above, various embodiments provide the metacoupler, waveguide metacoupler and structure including matching networks that may be implemented in a capacitive WPT system using various different types of metasurfaces and waveguides. However, the fringing field reduction designs described above are merely examples of many possible embodiments of fringing field reduction designs for capacitive WPT systems. Additional example embodiments are now further discussed with the addition of active field cancellation.

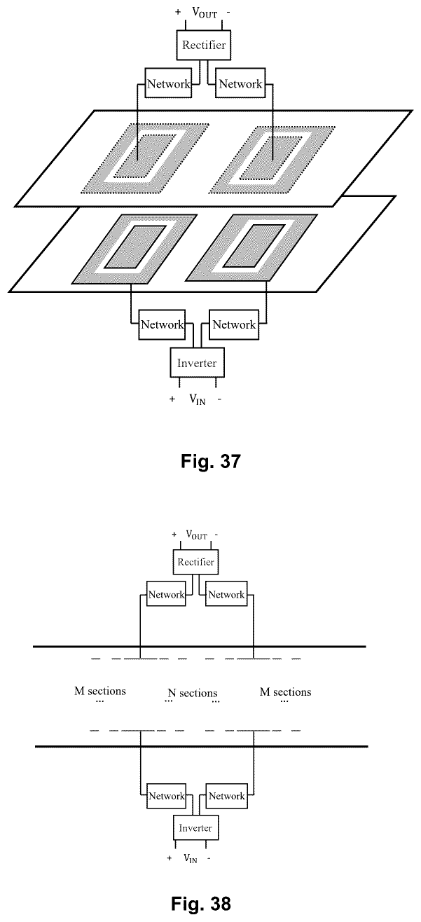

For example, in one possible implementation, the metacoupler can be designed to be circular, with two concentric circular rings and an air-gap between them, as shown in FIG. 11(b), previously discussed above, which provides an example of circular metacoupler implemented in a capacitive WPT system. Alternatively, a rectangular metacoupler can be designed so that the outer rectangles are extended inwards, beyond the boundary of the inner rectangles, as shown in FIG. 37.

In yet another possible implementation, the metacoupler in a capacitive WPT system can be implemented using N number of concentric plates, with each plate implemented using any 2-dimensional geometric shape, such that there exists an air-gap between the consecutive plate pairs, as shown in FIG. 38. The number of such plate segments can be any positive integer number.

Thus, capacitive metacoupler designs provided by the disclosed embodiments may actively reduce the fringing electric fields in capacitive WPT systems. Rectangular couplers may be used for in-motion EV charging to maximize overlap time between primary and secondary pads, unlike some conventional circular shapes. Metacouplers may use impedance sheets to reduce fringing electric fields, as shown in FIG. 40. These sheets can be inductive or capacitive, with capacitive designs being simpler, created by adding an air gap with a metallic ring around the coupling plate. FIGS. 41-42 show the cross-sectional and top view of one novel implementation of metacoupler-based charging pads, respectively. This design is similar to the above-described configuration that uses a C-shaped ring around the inner coupling plates, instead of having a full metallic ring. This approach is based on the need to only restrict the fringing electric fields outside the charging pads for improved safety. By eliminating the full rings and using the C-shaped ring structure as shown in FIG. 2(b), one enhances the power transfer density.

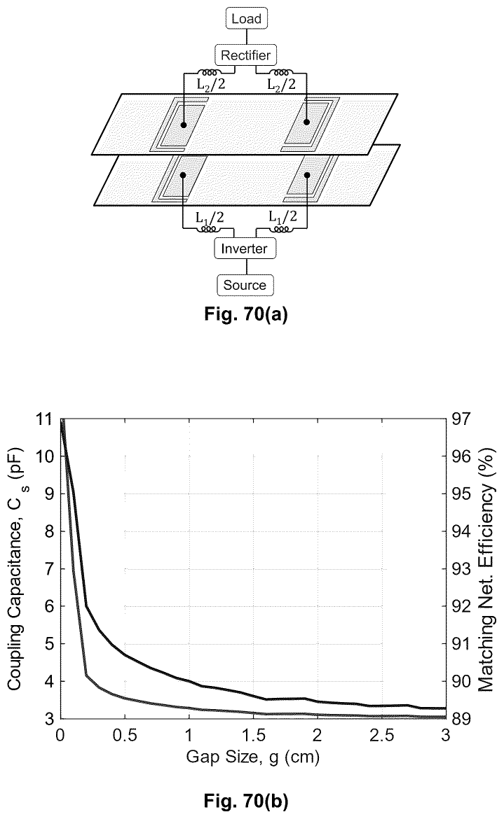

With this understanding in mind, the WPT system's configuration enables power transfer from the primary to the secondary-side exclusively through the inner plates, as illustrated in FIG. 70(a). While this setup facilitates a reduction in the electric field, its efficiency remains compromised. The introduction of a gap (g) between the inner and outer plates (or rings) concentrates the electric fields within this gap, effectively minimizing the fringing electric fields beyond the metasurface-based couplers. However, this arrangement decreases the overall coupling capacitance between the primary and secondary-side by introducing a series capacitance. Therefore, a reduction in efficiency of the WPT system is associated with the increase in gap size (g). This exhibits a clear tradeoff between the reduction of fringing electric field and the system's efficiency as depicted in FIG. 70(b).

To address this technological limitation, instead of having connections just to the inner plates, active cancellation designs provided in accordance with the disclosed embodiments may have connections to the outer plates as well, as depicted in FIG. 71. FIG. 71 illustrates an architecture for metasurface-based capacitive WPT systems transferring power from both outer rings and inner plates. This adaptation involves an additional inverter, matching network inductors (L₁′ and L₂′), and a rectifier. The high-frequency voltage is converted to DC output voltage by two rectifiers, each dedicated to the inner plates and outer rings. The DC output power from both may then be combined to supply a common load, leveraging the ease of paralleling dc power compared to AC power.

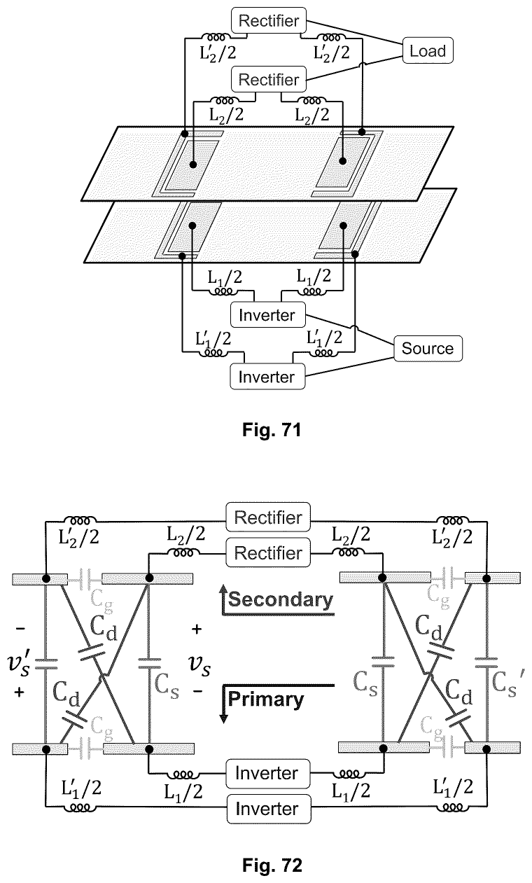

It should be appreciated that, intuitively, adding connections to the outer plates helps transfer power more efficiently by using the extra capacitance created by the outer rings. This can be seen from FIG. 72 that presents a cross-sectional view of a metacoupler (inner plates and outer rings). FIG. 72 illustrates a cross-sectional view of an architecture utilizing both inner plates and outer rings for power transfer. As seen, the new arrangement of having connections with the outer plates utilizes the coupling capacitors (highlighted in green) of outer rings to transfer power as well. The diagonal capacitance C_{d} between an inner plate and adjacent outer C-shaped ring can absorb some power while it is being transferred. Therefore, the gap, g, must be maintained between them such that the cross capacitance C_{d} is negligible as compared to the coupling capacitances Cₛ and Cₛ′.

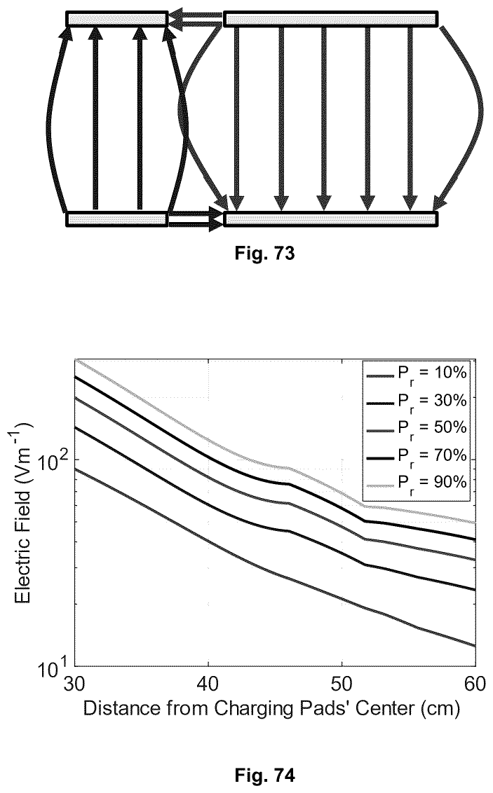

Moreover, utilizing both inner plates and outer rings for power transfer can, in itself, actually significantly increase fringing electric fields. To mitigate this, the inverters connected to the inner plates and outer rings may be operated completely or almost completely out-of-phase, enabling the oppositely directed electric fields to cancel out in the surrounding free space, as shown in FIG. 73.

For maximum active field cancellation, the voltages developed across the inner plates and surrounding outer rings should be completely out-of-phase (see FIG. 73).

As shown in FIG. 72, when the coupling capacitances (Cₛ, Cₛ′) and matching network capacitances (C₁, C₂, C₁′, C₂′) are identical, the voltages developed across the inner plates (Vₛ) and outer rings (Vₛ′) respectively, will be out-of-phase, thereby enabling the inverters to operate with a perfect 180° phase shift between each other. However, due to variations in the matching network components (inductances and capacitances) and operating frequency, the phase relationship of the inverters may need to be compensated from a perfect 180° shift to another value. To compensate for this variation, the inverters' phase shift may be adjusted dynamically. As a result, the phase shift between the two inverters can fall anywhere within the range of 0° to 360°, depending on the matching network impedance conditions.

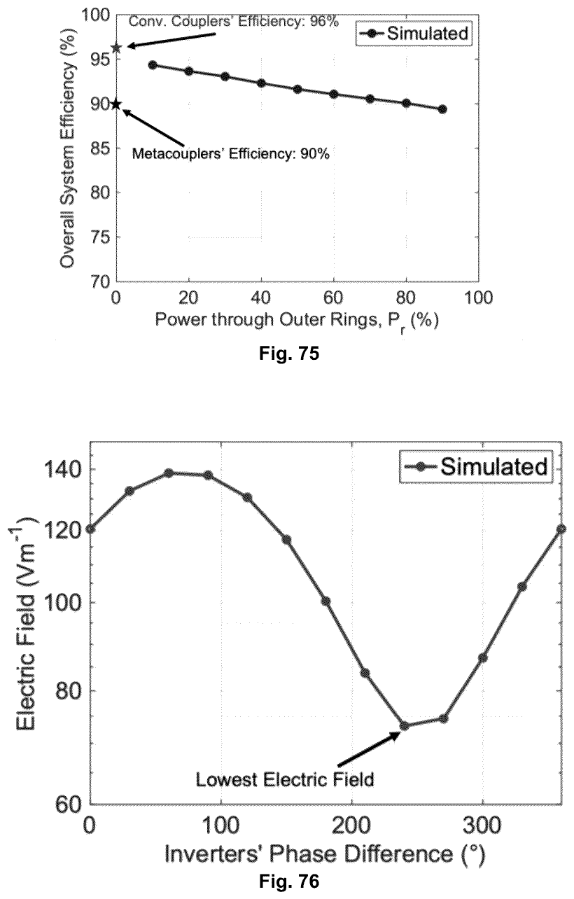

FIG. 73 provides a conceptual figure of a cross-sectional view of metacouplers when the inner plates and outer rings are out-of-phase. The resultant fringing electric field will reduce due to the oppositely directed electric field lines. Therefore, this approach may be implemented in an exemplary architecture illustrated in FIG. 75, which achieves two objectives: enhancing the metacoupler-based system's overall efficiency through power transfer by outer rings and reducing fringing electric field via active phase control of the inverters. It should be noted that there is some question whether adding extra matching network inductors, an inverter, and a rectifier to use the outer ring for power transfer could, in fact, lower the system's efficiency. However, as explained herein, choice of the appropriate percentage of power to transfer through the outer rings can prevent any overall efficiency loss from these additional components.

With this understanding of the interrelation between various design objectives for active field cancellation in a capacitive WPT system in mind, disclosed embodiments provide a methodology, which may be employed to design a capacitive WPT system for desired target specifications at chosen input (V_{IN}) and output (V_{OUT}) voltages. Thus, given a target output power P_{OUT} and power transfer density constraint Pa, the outer length (lₒ) and width (wₒ) of the coupling plates and peak voltage across the couplers V_{s,pk}, may be determined, as explained above. The dimensions of the inner copper plates, i.e., scaling constants Kₗ=lᵢ/lₒ for length and K_{w}=wᵢ/wₒ for width, and the gap g may be determined using conventionally known, as explained above.

FIG. 71 illustrates an exemplary design which utilizes outer rings for power transfer with the proportion of output power transferred through these rings being determinative of the design considerations. The percentage of total output power transferred through the outer rings be,

$${P}_{r} = \frac{{P}_{ring}}{{P}_{out}} ,$$

where P_{ring} is the output power transferred through the outer rings and Pₒᵤₜ is the total output power delivered. If more power is transferred through the outer rings than the inner plates, it will mean that a higher voltage is developed across the rings, leading to higher fringing electric fields near the edges of the charging pads.

FIG. 74 charts the effect of increasing percentage of power transferred through outer rings on simulated electric field for an example 6.78-MHz 2-kW capacitive WPT system, simulated in Ansys HFSS. As illustrated in FIG. 74, optimizing this distribution is determinative for controlling fringing electric field while maintaining system efficiency.

FIG. 75 charts the effect of increasing percentage of power transferred through outer rings on overall system efficiency for an example 6.78-MHz capacitive WPT system. FIG. 75 shows that system efficiency may decrease as more power is allocated to the outer rings. In implementation, outer rings may be smaller than inner plates to enable optimum low fringing electric fields. Therefore, transferring more power through smaller coupling capacitance will lead to greater losses. Also, it is evident from FIG. 75 that having connections with the outer rings in a metacoupler is beneficial in terms of efficiency as compared to metacouplers with no connections to the outer ring (87.6% efficiency).

As mentioned above, a degree of phase difference between the two inverters is the basis for canceling fringing electric fields by ensuring out-of-phase, or nearly out of phase voltages across the inner plates and outer rings. However, it should be understood that the required phase difference may not be 180°. The technical utility of leveraging this phase difference varies with matching network inductances and capacitances. Thus, in the case where both inner plates and outer rings have identical coupling capacitances, i.e., Cₛ, Cₛ′ and matching network capacitances i.e., C₁, C₂, C₁, C₂; the phase difference of the voltages developed across the inner plates (vₛ) and the outer rings (vₛ′) would be identical. Therefore, inverters can be made exactly 180° out-of-phase. However, when the matching networks are not identical, the voltages developed across the plates will be phase-shifted, therefore, the inverters need to operate with a phase difference other than 180° to offset for this difference.

FIG. 76 illustrates the variation of simulated electric field (Ansys HFSS) with the phase-shift between two inverters, located 79 cm from the center of charging pads. Thus, FIG. 76 represents the impact of phase difference between the actively controlled inverters. As should be evident, when the fringing electric fields from the inner plates and outer rings are oppositely directed, the overall resultant electric field would be the lowest. For this specific design example, when inverters are operated 240° out-of-phase, the fringing electric field is the lowest.

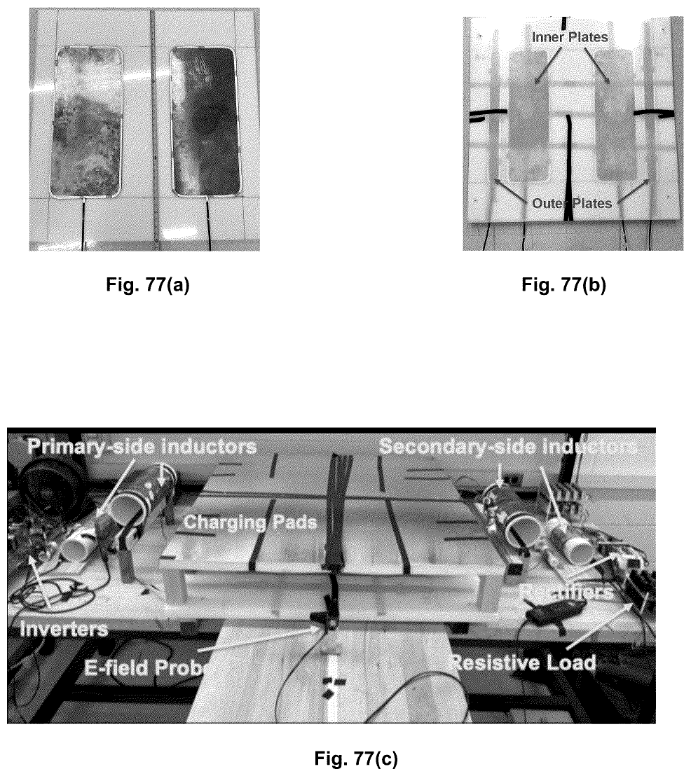

As a result of the design considerations detailed herein a 6.78-MHz, 12-cm air-gap, 1.1-kW capacitive WPT system may be designed for 95% efficiency and a 4× reduction in electric fields, all within safety standards. To verify the effectiveness of the metacoupler-based design with outer ring power transfer for reducing fringing electric fields, three 6.78-MHz, 12-cm gap, 1.1-kW capacitive WPT systems were built: a conventional coupler system, a metacoupler system without outer ring power transfer, and a metacoupler system transferring 10% of the output power through the outer rings. Matching networks were implemented using single-layered solenoid air-cored inductors. A 1μH single layered solenoid air-cored inductor was used as the ZVS inductor. GS66516T 650-V GaN FETs were used as inverter transistors. On the secondary-side, 650-V STPSC12065 Schottky diodes were used in the high frequency rectifier and wideband resistors were used to emulate battery. FIGS. 77(a)-(c) provide photographs of various experimental prototypes designed to test the aforementioned simulated design approaches. FIG. 77(a) is a photographic image of conventional couplers, (b) designed capacitive metacouplers, and (c) capacitive WPT experimental prototype. Of note, in the experimental implementations of the metacouplers, the outer plates are not C-shaped, as electric field reduction along an EV's length is unnecessary due to enough field decay over that long distance.

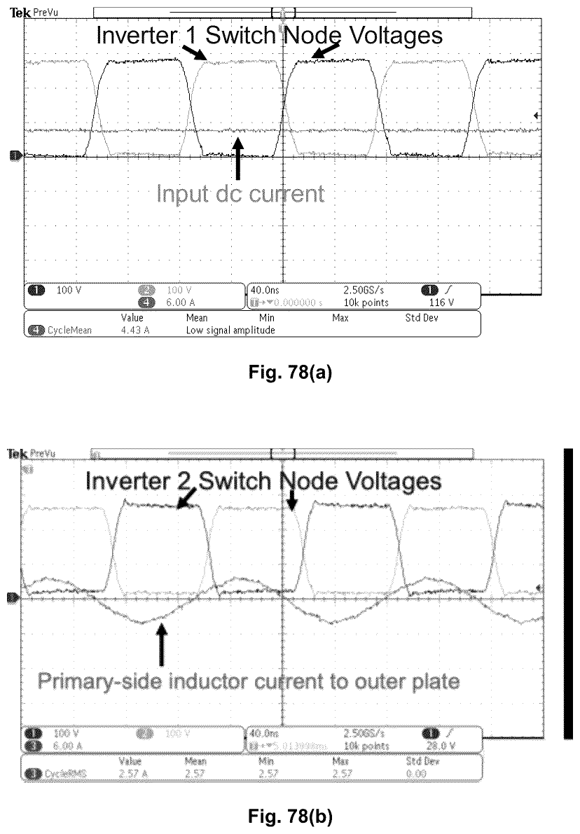

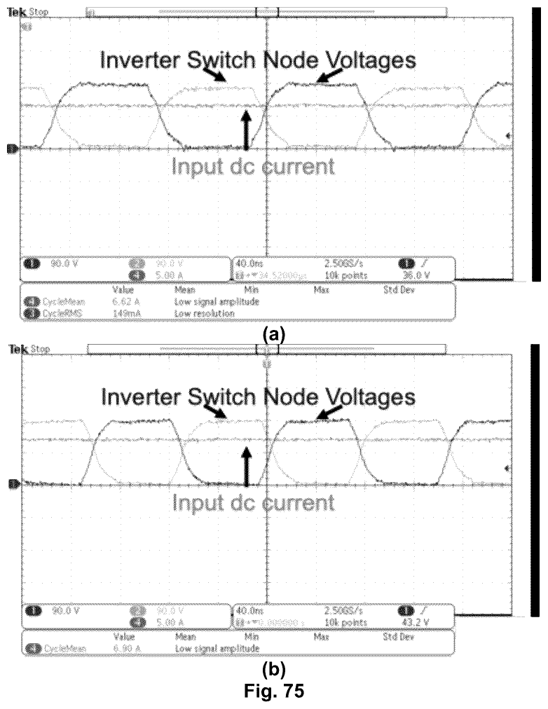

FIG. 78(a) charts measured operating waveforms of the capacitive WPT prototype, using metacouplers. FIG. 78(b) charts measured operating waveforms while delivering 1.1-kW at 87.6% efficiency to a 40Ω load, wherein 10% power is processed through outer plate and the phase difference between the two inverters is 240°. FIGS. 78(a)-(b) show the experimental waveforms obtained from the prototype metacoupler system transferring 10% of the output power through the outer rings and operating at 1.1 kW of output power, achieving a system efficiency of 87.6%.

For comparison, capacitive WPT system using conventional couplers, as depicted in FIG. 79(a), reached an efficiency of 91%. In contrast, metacouplers that lacked connections to the outer plates delivered power at an efficiency of 84%, as shown in FIG. 79(b). FIG. 79(a) charts measured operating waveforms of the capacitive WPT prototype using conventional couplers, achieving an overall efficiency of 91%. FIG. 79(b) charts measured operating waveforms using metacouplers in accordance with the disclosed embodiments, without power transfer from outer ring, achieving an overall efficiency of 84%.

This experimental data highlights the benefits of transferring 10% of the output power through the outer rings of the metacoupler implemented system, which enhances efficiency by incorporating outer plates for power transfer.

FIG. 80 charts measured operating waveforms of the capacitive WPT prototype in FIG. 77(b) while delivering 1.1-kW at 87.6% efficiency to a 40Ω load. Output voltage shown in the scope is the actual output voltage divided by four, as it is being measured across a resistor bank out of four series connected resistor banks.

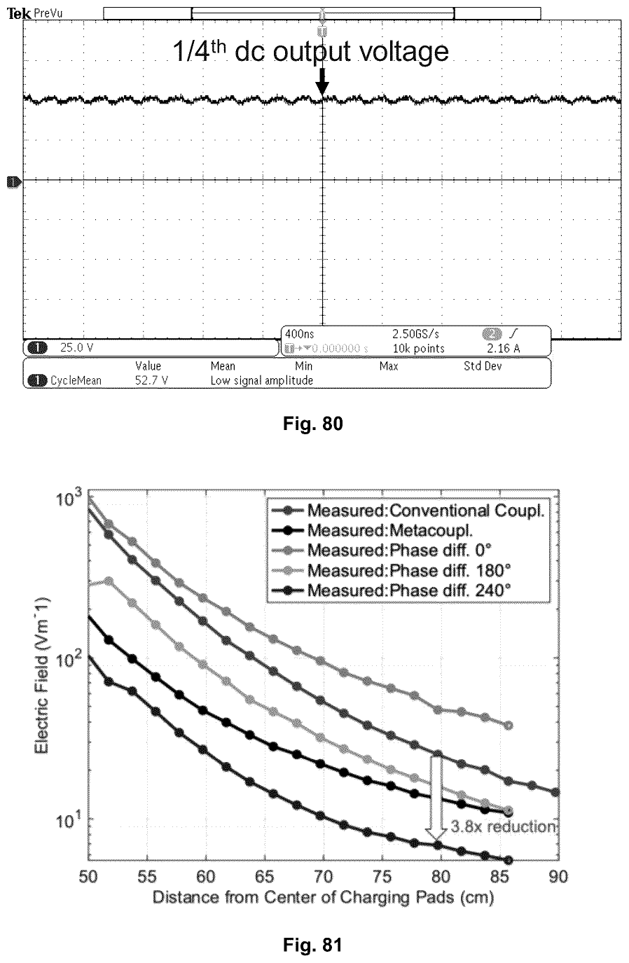

Furthermore, this achieves a significant reduction in fringing electric field-specifically, a twofold (2×) decrease compared to setups without active field cancellation and an overall 3.8× reduction when compared to conventional couplers, as evidenced from FIG. 81. FIG. 81 charts measured electric field at 130 W of output power, wherein an experimental 3.8× reduction in electric field may be observed to a conventional coupler.

Additionally, when the phase difference between the inverters is 0°, the electric fields from the inner and outer plates combine, resulting in higher field intensity. The resultant fields reach their minimum when the phase difference is adjusted to 240°, which aligns with theoretical discussions above relating to FIG. 76.

Experimental validation on a 6.78-MHz, 12-cm air-gap WPT prototype demonstrated significant improvements by providing a system achieving an efficiency of 87.6%, higher than metacoupler systems without outer ring connections, which reached 84% efficiency, though it remained slightly below the 91% efficiency seen with using conventional plates. Importantly, the active cancellation design accomplished a 3.8× reduction in fringing electric fields compared to conventional systems, showcasing the effectiveness of the active field cancellation method. The analysis highlighted the relationship between power distribution, phase difference, and field reduction, with optimal cancellation observed at a 240° phase difference between inverters. This configuration also minimized electric field intensity in surroundings.

Of note, the observed experimental system efficiencies are somewhat lower than those projected by simulations. This discrepancy can be attributed to the use of single-layered solenoid air-cored inductors within the matching networks. These inductors have a quality factor of 900, which, while high, does not match the ideal inductors assumed in simulation environments. Multi-MHz air-core inductors with quality factors reaching up to 2000 can be developed, offering the potential for enhanced overall system efficiency. Additionally, for compact designs, multi-MHz core-based inductors present a viable solution.

Table III shows the physical dimensions of the designed 6.78-MHz 12-cm air-gap 1.1-kW capacitive WPT system.

TABLE III
PHYSICAL DIMENSIONS OF THE DESIGNED
CHARGING PADS USING METACOUPLERS

| | | | | | | Charging | Charging |
|---|---|---|---|---|---|---|---|
| | | Lateral | | Length | Width | Pad Total | Pad Total |
| Length, | Width, | Separation, | Gap size, | Scaling | Scaling | Length, L | Width, W |
| l (cm) | w (cm) | s (cm) | g (mm) | constant K₁ | constant K_{w} | (cm) | (cm) |
| 60 | 27.5 | 20 | 30 | 1 | 0.2 | 91 | 91 |

Thus, this aspect of disclosed embodiments have been described that present a novel approach for capacitive WPT systems, utilizing metasurface-based couplers with active field cancellation. As a result, disclosed embodiments effectively address challenges found in conventional capacitive WPT designs, particularly in reducing fringing electric fields while maintaining high efficiency, by providing a design that strategically distributes power transfer between inner plates and outer rings and ensures appropriate phase-shift to minimize surrounding electric fields.

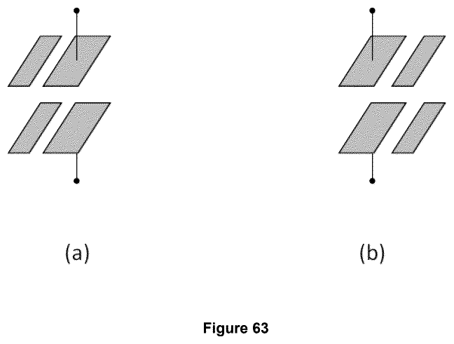

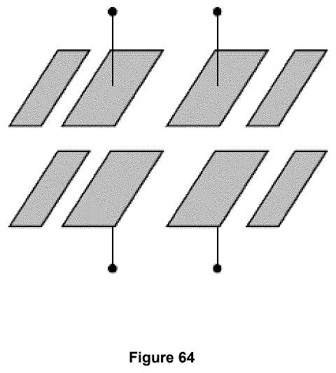

Returning to FIGS. 63(a)-(b) referenced earlier, it should be understood that a metacoupler designed in accordance with at least some of the disclosed embodiments may also include a fourth conductive plate laterally adjacent to the other of the first or the second conductive plate (i.e., adjacent to the plate that does not already have a laterally adjacent plate) on the side of the other plate such that the fourth conductive plate is coupled to the third conductive plate. In this configuration, there is the potential for connection of the unconnected outer plates to provide active field cancellation as has been disclosed herein.

In such an implementation, for example, as shown in FIG. 82, a capacitive wireless power transfer system may be configured as shown in FIG. 67 but with an additional inverter and matching network pair and an additional matching network and rectifier interfaced with the laterally adjacent plates to perform active field cancellation. In this implementation, the additional plates are interfaced with the additional pairs to perform active field cancellation. More specifically, in this configuration the laterally adjacent plates are connected to the output port of the second inverter through the third matching network and the laterally adjacent plates are connected to the output port of the second rectifier through the fourth matching network. In this implementation, the two inverters may operate with an appropriate phase-shift to perform active field cancellation, as discussed above.

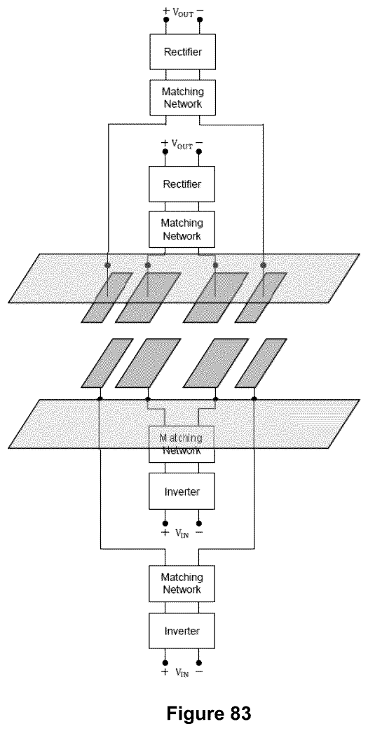

Still further, it should be appreciated that a capactive WPT system may be configured by implementing a pair of metacouplers positioned in a waveguide structure formed by a pair of elongated conductive plates of FIG. 69 in conjunction with the active field cancellation explained with reference to FIG. 82. A conceptual depiction of this implementation is shown in FIG. 83.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

Various aspects of technical utility arise from the various features of the methods, apparatuses, and systems described herein. It will be noted that alternative embodiments of the methods, apparatuses, and systems of the present disclosure may not include all of the features described yet still benefit from at least some of the advantages of such features.

For example, disclosed embodiments may provide a metacoupler that includes a first conductive plate, a second conductive plate coupled to the first conductive plate, a third conductive plate laterally adjacent to one of the first or the second conductive plate on at least one side of the first or the second conductive plate, an input terminal connected to the first conductive plate, and an output terminal connected to the second conductive plate.

Such a metacoupler may also include a plurality of laterally adjacent conductive plates laterally adjacent to the first or the third conductive plate on at least one side of the first or the third conductive plate. Such a metacoupler may include a fourth conductive plate laterally adjacent to the other of the first or the second conductive plate on at least one side of the first or the second conductive plate. Such a metacoupler may include a plurality of laterally adjacent conductive plates laterally adjacent to the second or the fourth conductive plate on at least one side of the second or the fourth conductive plate. Such a metacoupler may include at least one pair of laterally adjacent conductive plates are connected using at least one lumped impedance element.

Likewise, such a metacoupler may be rectangular with outer rectangles extended inwards beyond a boundary of inner rectangles or circular with two concentric circular rings and an air-gap provided therebetween.

Such a metacoupler may include a plurality of concentric plates, with each plate implemented as a two-dimensional geometric shape, such that an airgap is provided between the consecutive plate pairs. Such a metacoupler may be rectangular wherein the third conductive plate is C shaped.

In accordance with various disclosed embodiments, a waveguide-metacoupler may be implemented, wherein the metacoupler is placed within a waveguide structure formed by a pair of elongated conductive plates.

Disclosed embodiments may provide a metacoupler, wherein the air gap has a distance or width of at least 0.5 mm, or 1 mm to 50 mm, including any values therewithin or any subranges therebetween, or preferably 1-30 mm. Such a metacoupler wherein each of the conductive plates has a first dimension (e.g., the longest dimension or length) of 1 cm to 200 cm, including any values therewithin or any subranges therebetween, or preferably 1-50 cm; a second dimension (e.g., the second longest dimension or width) of 0.5 cm to 100 cm, including any values therewithin or any subranges therebetween, or preferably 0.5-30 cm, and a third dimension (e.g., a thickness) of 0.1 mm to 10 mm including any values therewithin or any subranges therebetween, or preferably 0.1 mm-1 mm. Such a metacoupler may have a shape that is elliptical with at least one concentric elliptical ring and an air-gap between two adjacent conductive plates. Optionally, the gap between the adjacent concentric conductive plates has a distance or width of at least 0.5 mm, or 1 mm to 50 mm, including any values therewithin or any subranges therebetween, or optionally 1-30 mm.

Such a metacoupler may have a first, second, optionally third ratio and/or optionally fourth ratio of the semi-major axe and semi-minor axe for a first, second, optionally third and/or optionally fourth plate of greater than 1, or 1.01 to 10 including any values therewithin or any subranges therebetween. Such a metacoupler may be configured to operate at 1 MHz to 500 MHz, including any values therewithin or any subranges therebetween, preferably 3 MHz to 50 MHz.

Optionally, the each of the conductive plates may have a first dimension (e.g the longest dimension or length) of 1 cm to 200 cm, including any values therewithin or any subranges therebetween, or preferably 1-50 cm; a second dimension (e.g the second longest dimension or width) of 0.5 cm to 100 cm, including any values therewithin or any subranges therebetween, or preferably 0.5-30 cm, and a third dimension (e.g. a thickness) of 0.1 mm to 10 mm including any values therewithin or any subranges therebetween, or preferably 0.1 mm-1 mm.

As explained throughout the present application, the disclosed embodiments may be implemented to provide a capacitive wireless power transfer system that includes at least one metacoupler so described. Such a capacitive wireless power transfer system may include two such metacouplers, wherein the input terminals of the two metacouplers are connected to the output port of an inverter through a first matching network and the output terminals of the two metacouplers are connected to the input port of a rectifier through a second matching network. Such a capacitive wireless power transfer system may include at least one metacoupler placed within a waveguide structure formed by a pair of elongated conductive plates to form a waveguide-metacoupler. Such a capacitive wireless power transfer system may include a plurality of metacouplers, wherein the input terminals of at least two of the plurality of metacouplers are connected to the output port of an inverter through a first matching network and the output terminals of the two metacouplers are connected to the input port of a rectifier through a second matching network. Further, such a capacitive wireless power transfer system may include a plurality of transmitter-side metacoupler plates, included in the plurality of metacouplers, connected to a plurality of inverters through a plurality of matching networks and a plurality of receiver-side metacoupler plates are connected to a plurality of rectifiers through a plurality of matching networks.

Such a capacitive wireless power transfer system may be used in high-power charging applications which exceed 50 kW, wherein the system includes a plurality of inverters, matching networks and rectifiers, wherein one of the plurality of inverters drives a subset of plates of the metacouplers and another inverter of the plurality of inverters drives another subset of the metacoupler operating with a 180° phase-shift between each other to perform active field cancellation. Such charging systems may be effectively used for a charging system for charging an electric vehicle.

In particular, such capacitive wireless power transfer systems may be configured to operate at 1 MHz to 500 MHz, including any values therewithin or any subranges therebetween, preferably 3 MHz to 50 MHz.

In particular, it should be understood that the disclosed technical innovations may be used to reduce fringing fields generated during wirelessly power transfer to an electricity powered device by performing multi-MHz capacitive wireless power transfer using a plurality of metacouplers each including a first conductive plate, a second conductive plate coupled to the first conductive plate, a third conductive plate laterally adjacent to one of the first or the second conductive plate on at least one side of the first or the second conductive plate, an input terminal connected to the first conductive plate, and an output terminal connected to the second conductive plate, and controlling wireless power transfer operation to drive the plurality of metacouplers, wherein the controlled operation of the plurality of metacouplers produces an impedance property that restricts electric field lines from emanating outwards from the metacouplers, thereby providing increased focus of near-field energy transfer, wherein at least one of the plurality of metacouplers is included in a waveguide structure formed by a two elongated metal sheets separated by a distance. In such methodologies, the input terminals of at least two of the plurality of metacouplers may be connected to the output port of an inverter through a first matching network and the output terminals of the plurality of metacouplers may be connected to the input port of a rectifier through a second matching network. Further, such methodologies may utilize a plurality of transmitter-side metacoupler plates included in the plurality of metacouplers connected to a plurality of inverters through a plurality of matching networks and a plurality of receiver-side metacoupler plates connected to a plurality of rectifiers through a plurality of matching networks.

Such methodologies may be used to perform wireless power transfer at 1 MHz to 500 MHz, including any values therewithin or any subranges therebetween, preferably 3 MHz to 50 MHz. Such methodologies may be used to perform wireless power transfer in high-power charging applications which exceed 50 kW using a plurality of inverters, matching networks and rectifiers, wherein one of the plurality of inverters drives a subset of plates of the metacouplers and another inverter of the plurality of inverters drives another subset of the metacoupler operating with a 180° phase-shift between each other to perform active field cancellation.

As described herein, these methodologies may use a metacoupler comprises: at least two concentric conductive plates, and at least one air-gap between each two adjacent conductive plates; at least three concentric conductive plates, a first air-gap between a first conductive plate and a second conductive plate, and a second air-gap between the second conductive plate and a third conductive plate; and/or at least one of the at least two concentric conductive plates is circular, elliptical, square, elliptical, polygonal, circular ring, elliptical ring, square ring, elliptical ring, polygonal ring or any combinations thereof.

Those of ordinary skill in the art may readily devise their own implementations of the methods, apparatuses, and systems that incorporate one or more of the features of the present invention and fall within the spirit and scope of the present disclosure as defined by the appended claims.

### APPENDICES

### Appendix A

This Appendix shows specific details regarding a derivation of the transformation of FIG. 46(a) to a four-capacitance model, FIG. 46(b). Consider FIG. 46(a) redrawn again as FIG. 54, highlighting the pi-network within the circuit model. FIG. 54 illustrates an equivalent circuit model after split inductor symmetry and incorporating diagonal capacitances (pi-network within the circuit highlighted in green).

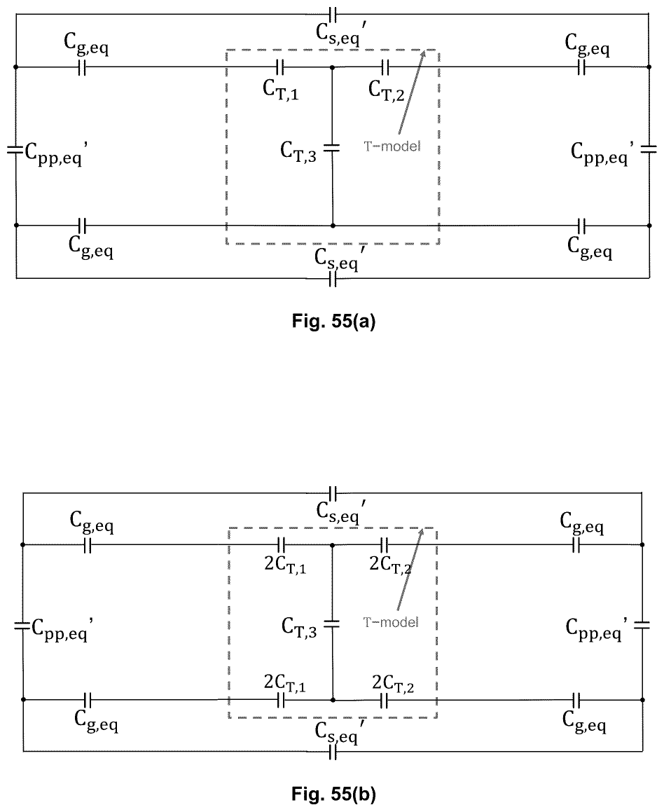

This pi-network can be transformed to an equivalent T-network, resulting in FIGS. 55(a)-(b). FIG. 55(a) illustrates an equivalent circuit model after Pi-T transformation (T-network within the circuit highlighted in green). FIG. 55(b) illustrates an equivalent circuit model after splitting capacitors CT,1 and CT,2.

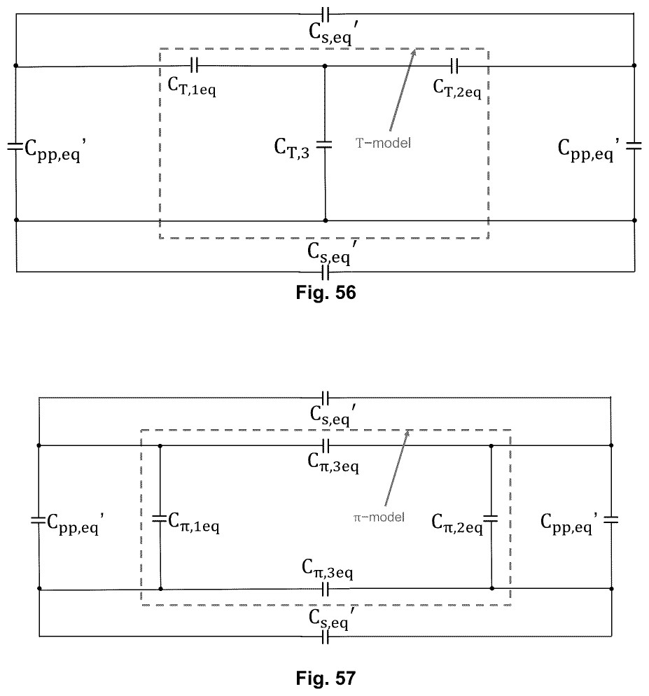

FIG. 56 represents the equivalent circuit model after combining C_{g,eq} and split C_{T,1} & C_{T,2} capacitances. The highlighted T-network in FIG. 56 can be transformed to a pi-network. FIG. 56 illustrates an equivalent circuit model after combining Cg,eq and split CT,1 & CT,2. capacitances (T-network within the circuit highlighted in green).

FIG. 57 illustrates an equivalent circuit model after T-Pi transformation (pi-network within the circuit highlighted in green). Again, the resultant capacitors can be split into two, one for each forward and return current path of the model shown in FIG. 57.

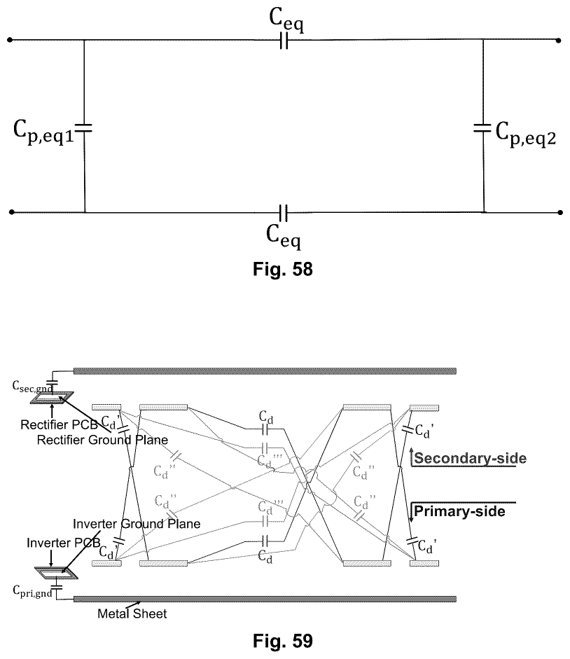

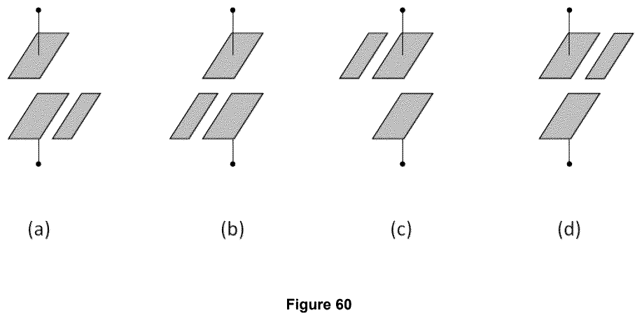

FIG. 58 illustrates a final simplified four-capacitance model. FIG. 59 illustrates a physical model of the couplers with different diagonal (or cross) capacitances. By absorbing capacitors C_{pp,eq′} and C_{s,eq′} to the transformed pi-model, we can deduce an equivalent four-capacitance model shown in FIG. 58.

### Appendix B

This appendix explains the expressions for equivalent capacitance models presented in Appendix A.

FIG. 54 represents the equivalent circuit model after FIG. 45(b) is conventionally known. The equivalent capacitance expressions are given as:

$$\begin{matrix}{C}_{{s}_{eq}} = {C}_{s} - {C}_{d} - 2 {C}_{d}^{′} - 2 {C}_{d}^{″} & ( 1 ) \\ {C}_{{s}_{eq}}^{′} = {C}_{s}^{′} - 2 {C}_{d}^{′} - 2 {C}_{d}^{′′} - {C}_{d}^{′′′} & ( 2 ) \\ {C}_{{pp}_{eq , pri}} = {C}_{pp} + \frac{{C}_{p , pri}}{2} + \frac{{C}_{pd , s ec}}{2} + {C}_{d} + {C}_{d}^{′} & ( 3 ) \\ {C}_{{pp}_{eq , s ec}} = {C}_{pp} + \frac{{C}_{p , s ec}}{2} + \frac{{C}_{pd , pri}}{2} + {C}_{d} + {C}_{d}^{′} & ( 4 ) \\ {C}_{{pp}_{eq , pri}}^{′} = {C}_{p p}^{′} + \frac{{C}_{p , pri}^{′}}{2} + \frac{{C}_{pd , s ec}^{′}}{2} + {C}_{d}^{′} + {C}_{d}^{″} + {C}_{d}^{′′′} & ( 5 ) \\ {C}_{{pp}_{eq , s ec}}^{′} = {C}_{pp}^{′} + \frac{{C}_{p , s ec}^{′}}{2} + \frac{{c}_{pd , pri}^{′}}{2} + {C}_{d}^{′} + {C}_{d}^{″} + {C}_{d}^{′′′} & ( 6 )\end{matrix}$$

All diagonal capacitances defined in equations (1)-(6) are illustrated in FIG. 59. FIG. 63 illustrates a final simplified four-capacitance model. FIG. 59 illustrates a physical model of the couplers with different diagonal (or cross) capacitances. C_{d} represents the diagonal capacitances between all the inner plates (highlighted in red). C_{d}′ represents the diagonal capacitances between adjacent inner plates and outer rings (highlighted in dark blue). Diagonal capacitances between non-adjacent inner plates and outer rings (highlighted in green) are represented as C_{d}″. Lastly, the diagonal capacitances between all the outer rings (highlighted in aqua blue) are represented as C_{d}′″.

It is assumed that both primary-side and secondary-side construction is symmetric. Hence,

Cₚₚ_{_{eq,pri}}=Cₚₚ_{_{eq,sec}}=Cₚₚ_{_{eg}} (7)

Cₚₚ_{_{eq,pri}}′=Cₚₚ_{_{eq,sec}}′=Cₚₚ_{_{eg}}′ (8)

FIG. 55(a) represents the equivalent model after Pi-T transformation. The resulting expressions after the transform are written as follows:

$$\begin{matrix}{C}_{T , 1} = {C}_{{pp}_{eq}} + {C}_{s , eq} & ( 9 ) \\ {C}_{T , 2} = \frac{2 ( {C}_{pp , eq}^{2} + {C}_{s , eq} {C}_{pp , eq} )}{{C}_{s , eq}} & ( 10 ) \\ {C}_{T , 3} = {C}_{{pp}_{eq}} + {C}_{s , eq} & ( 11 )\end{matrix}$$

FIG. 56 represents the equivalent T-model after absorbing C_{g,eq}. The resulting expressions are given as:

$$\begin{matrix}{C}_{T , 1 eq} = \frac{{C}_{T , 1} * {C}_{e , eq}}{2 {C}_{T , 1} + {C}_{g} , eq} & ( 12 ) \\ {C}_{T , 2 eq} = \frac{{C}_{T , 2} * {C}_{g , eq}}{2 {C}_{T , 2} + {C}_{g} , eq} & ( 13 )\end{matrix}$$

FIG. 57 represents the T-Pi transformation of the previous T-network. The resulting expressions are given by:

$$\begin{matrix}{C}_{π , 1 eq} = \frac{{C}_{T , 1 eq} * {C}_{T , 3}}{{C}_{T , 1 eq} + {C}_{T , 2 eq} + {C}_{T , 3}} & ( 14 ) \\ {C}_{π , 2 eq} = \frac{{C}_{T , 2 eq} * {C}_{T , 3}}{{C}_{T , 1 eq} + {C}_{T , 2 eq} + {C}_{T , 3}} & ( 15 ) \\ {C}_{π , 3 eq} = 2 \frac{{C}_{T , 1 eq} * {C}_{T , 2 eq}}{{C}_{T , 1 eq} + {C}_{T , 2 eq} + {C}_{T , 3}} & ( 16 )\end{matrix}$$

The expressions for the final four-capacitance model in FIG. 58 are represented as:

$$\begin{matrix}{C}_{eq} = {C}_{π , 3 eq} + {C}_{s , eq}^{′} & ( 17 ) \\ {C}_{p , eq 1} = {C}_{π , 1 eq} + {C}_{pp , eq}^{′} & ( 18 ) \\ {C}_{p , eq 2} = {C}_{π , 2 eq} + {C}_{p p , eq}^{′} & ( 19 )\end{matrix}$$

What is claimed is:

1. A metacoupler comprising:
a first conductive plate;
a second conductive plate coupled to the first conductive plate;
a third conductive plate laterally adjacent to one of the first or the second conductive plates on at least one side of the first or the second conductive plate;
an input terminal connected to the first conductive plate; and
an output terminal connected to the second conductive plate.

2. The metacoupler of claim 1, further comprising a plurality of conductive plates laterally adjacent to the first and/or the second and/or the third conductive plate on at least one side of the first and/or the second and/or the third conductive plate.

3. The metacoupler of claim 2, wherein at least one pair of laterally adjacent conductive plates are coupled to one another by at least one lumped impedance element.

4. A capactive wireless power transfer system comprising a pair of metacouplers as recited in claim 2, wherein the input terminals of the pair of metacouplers are electrically connected to the output port of an inverter through a first matching network and the output terminals of the pair of metacouplers are connected to the input port of a rectifier through a second matching network.

5. The capacitive wireless power transfer system of claim 4, wherein the system is configured to operate at 1 MHz to 500 MHz, including any values therewithin or any subranges therebetween, or 3 MHz to 50 MHz.

6. A charging system for charging an electric vehicle including the capacitive wireless power transfer system of claim 4.

7. A capactive wireless power transfer system of claim 4, wherein the pair of metacouplers are placed within a waveguide structure formed by a pair of elongated conductive plates.

8. The capactive wireless power transfer system of claim 4, wherein the plates laterally adjacent to the plates connected to the input terminals of the two metacouplers are connected to the output port of a second inverter through a third matching network;
the plates laterally adjacent to the plates connected to the output terminals of the two metacouplers are connected to the output port of a second rectifier through a fourth matching network; and
the two inverters operate with a phase-shift to perform active field cancellation.

9. A capactive wireless power transfer system of claim 8, wherein the pair of metacouplers are placed within a waveguide structure formed by a pair of elongated conductive plates.

10. The capacitive wireless power transfer system of claim 8, wherein the system is used in high-power charging applications which exceed 5 kW, wherein the system includes a plurality of inverters, matching networks and rectifiers, wherein one of the plurality of inverters drives a subset of plates of the metacouplers and another inverter of the plurality of inverters drives another subset of the metacoupler operating with a phase-shift between each other to perform active field cancellation.

11. The metacoupler of claim 1, further comprising a fourth conductive plate laterally adjacent to the other of the first or the second conductive plate on the side of the other plate such that the fourth conductive plate is coupled to the third plate.

12. A pair of the metacouplers recited in claim 11, wherein the pair of metacouplers are coupled together by placing them laterally adjacent to each other.

13. The waveguide-metacoupler structure comprising a pair of metacouplers as recited in claim 4, wherein the pair of metacouplers are placed within a waveguide structure formed by a pair of elongated conductive plates.

14. The metacoupler of claim 1, wherein the metacoupler comprises at least two concentric conductive plates, and at least one gap between each two adjacent conductive plates.

15. The metacoupler of claim 14, wherein at least one of the at least two concentric conductive plates is circular, elliptical, square, elliptical, polygonal, circular ring, elliptical ring, square ring, elliptical ring, polygonal ring or any combinations thereof.

16. The metacoupler of claim 15, wherein the gap between the adjacent concentric conductive plates has a distance or width of at least 0.5 mm, or 1 mm to 50 mm, including any values therewithin or any subranges therebetween, or 1-30 mm.

17. The metacoupler of claim 14, wherein each of the conductive plates has a first dimension of 1 cm to 200 cm, including any values therewithin or any subranges therebetween, or 1-50 cm; a second dimension of 0.5 cm to 100 cm, including any values therewithin or any subranges therebetween, or 0.5-30 cm, and a third dimension of 0.1 mm to 10 mm including any values therewithin or any subranges therebetween, or 0.1 mm-1 mm.

18. The metacoupler of claim 1, wherein the shape of the metacoupler is elliptical with at least one concentric elliptical ring and a gap between two adjacent conductive plates.

19. The metacoupler of claim 18, wherein the metacoupler is elliptical having a first, second, optionally third ratio and/or optionally fourth ratio of the semi-major axis and semi-minor axis for a first, second, optionally third and/or optionally fourth plate of greater than 1, or 1.01 to 10 including any values therewithin or any subranges therebetween.

20. The metacoupler of claim 1, wherein the metacoupler is configured to operate at 1 MHz to 500 MHz, including any values therewithin or any subranges therebetween, or 3 MHz to 50 MHz.

21. The metacoupler of claim 1, wherein the metacoupler is rectangular with outer rectangles extended inwards beyond a boundary of inner rectangles.

22. The metacoupler of claim 1, wherein the metacoupler is circular with two concentric circular rings and an air-gap provided therebetween.

23. The metacoupler of claim 1, wherein the metacoupler includes a plurality of concentric plates, with each plate implemented as a two-dimensional geometric shape, such that an airgap is provided between the consecutive plate pairs.

24. The metacoupler of claim 1, wherein the metacoupler is rectangular wherein the third conductive plate is C shaped.

25. A waveguide-coupler structure comprising:
a first pair of conductive plates connected to the input port;
a second pair of conductive plates connected to the output port;
wherein the first and second pairs of conductive plates are separated from each other by a gap;
wherein the first and second pairs of conductive plates are placed within a waveguide structure formed by a pair of elongated conductive plates.

26. A capactive wireless power transfer system comprising the structure of claim 25, wherein the input port of the structure connected to the output port of an inverter through a first matching network and the output port of the structure connected to the input port of a rectifier through a second matching network.

27. A method for reduction of fringing fields generated during wireless power transfer to an electricity powered device, the method comprising:
performing multi-MHz capacitive wireless power transfer using a plurality of metacouplers each including a first conductive plate, a second conductive plate coupled to the first conductive plate, a third conductive plate laterally adjacent to one of the first or the second conductive plate on at least one side of the first or the second conductive plate, an input terminal connected to the first conductive plate, and an output terminal connected to the second conductive plate; and
controlling wireless power transfer operation to drive the plurality of metacouplers, wherein the controlled operation of the plurality of metacouplers produces an impedance property that restricts electric field lines from emanating outwards from the metacouplers, thereby providing increased focus of near-field energy transfer,
wherein at least one of the plurality of metacouplers is included in a waveguide structure formed by a two elongated metal sheets separated by a distance.

28. The method of claim 27, wherein the input terminals of at least two of the plurality of metacouplers are connected to the output port of an inverter through a first matching network and the output terminals of the plurality of metacouplers are connected to the input port of a rectifier through a second matching network.

29. The method of claim 27, wherein a plurality of transmitter-side metacoupler plates included in the plurality of metacouplers are connected to a plurality of inverters through a plurality of matching networks and a plurality of receiver-side metacoupler plates are connected to a plurality of rectifiers through a plurality of matching networks.

30. The method of claim 27, wherein the wireless power transfer is performed in high-power charging applications which exceed 5 kW using a plurality of inverters, matching networks and rectifiers, wherein one of the plurality of inverters drives a subset of plates of the metacouplers and another inverter of the plurality of inverters drives another subset of the metacoupler operating with a phase-shift between each other to perform active field cancellation.

31. The method of claim 27, wherein the wireless power transfer system is configured to operate at 1 MHz to 500 MHz, including any values therewithin or any subranges therebetween, or 3 MHz to 50 MHz.
